(19) United States
(12) Patent Application Publication
(10) Pub. No.: US 2021/0343182 A1
(43) Pub. Date: Nov. 4, 2021

(54) VIRTUAL-REALITY-BASED PERSONAL PROTECTIVE EQUIPMENT TRAINING SYSTEM

(71) Applicant: 3M INNOVATIVE PROPERTIES COMPANY, St. Paul, MN (US)

(72) Inventor: Jamie L. Lu, Woodbury, MN (US)

(21) Appl. No.: 17/309,046

(22) PCT Filed: Sep. 19, 2019
(86) PCT No.: PCT/IB2019/057932

§ 371 Date: Apr. 16, 2021

Related U.S. Application Data
(60) Provisional application No. 62/748,282, filed on Oct. 19, 2018.

(51) Int. Cl. G09B 19/24; G09B 9/00

(52) U.S. Cl. CPC G09B 19/24; G09B 9/00

(57) ABSTRACT

In some examples, a system includes an augmented and/or virtual reality (AVR) device and at least one computing device. The computing device may include a memory and one or more processors coupled to the memory. The memory may include instructions that when executed by the one or more processors output, for display by the AVR device, a first graphical user interface, wherein the graphical user interface includes a plurality of graphical elements associated with a respective training module of a plurality of training modules, wherein each training module represents a respective training environment associated with one or more articles of personal protective equipment (PPE). The computing device may further determine, based on sensor data output by one or more sensors, a selection of a graphical element of the plurality of graphical elements, the graphical element associated with a particular training module of the plurality of training modules; and output, for display by the AVR device, a second graphical user interface, wherein the second graphical user interface corresponds to the particular training module. Finally, the computing device may execute the PPE training module.

### TECHNICAL FIELD

The present disclosure relates to the field of personal protective equipment.

### BACKGROUND

Personal protective equipment (PPE) may be used to help protect a user (e.g., a worker) from harm or injury from a variety of causes. For example, workers may wear eye protection, such as safety glasses, in many different work environments. As another example, workers may use fall protection equipment when operating at potentially harmful or even deadly heights. As yet another example, when working in areas where there is known to be, or there is a potential of there being, dusts, fumes, gases or other contaminants that are potentially hazardous or harmful to health, it is usual for a worker to use a respirator or a clean air supply source, such as a powered air purifying respirators (PAPR) or a self-contained breathing apparatus (SCBA). Other PPE may include, as non-limiting examples, hearing protection, head protection (e.g., visors, hard hats, or the like), protective clothing, or the like.

### SUMMARY

The present disclosure describes techniques for training workers on personal protective equipment to be utilized in hazardous work environments. For example, a virtual reality (VR) system may include a VR display configured to be worn by a user and one or more sensors configured to detect motion of the user while wearing the VR display. The VRM system may include a personal protective equipment (PPE) training application that includes one or more training modules. Each training module may correspond to a respective training environment. In other words, the VR system may enable a worker to select a training module from the plurality of training modules and a VR display may output a virtual environment corresponding the selected training module. For example, the VR display device may output a graphical user interface corresponding to various virtual training environment and may receive data from the sensors as a user interacts with the virtual training environment. Example training environments include construction sites, laboratories, confined spaces, warehouses, manufacturing facilities, among others.

A computing device may output, to a VR display device, data representing graphical user interfaces corresponding to the various training modules. For example, the graphical user interface may include a graphical object representing a virtual worker within the virtual environment and a notification instructing the user to identify whether the virtual worker is wearing appropriate PPE given the virtual environment and hazards associated with the virtual environment. As another example, the graphical user interface may include graphical objects representing a virtual worker and virtual PPE and a notification instructing the user to identify whether the virtual worker is utilizing the virtual PPE properly (e.g., according to specifications or regulations). As yet another example, the graphical user interface may include graphical objects representing respective virtual PPE and a notification instructing the user to select the appropriate virtual PPE for a given virtual work environment.

The computing device receives sensor data indicative of the user's movements as the user interacts with the virtual environment. The computing device may determine whether the user performs a task appropriately (e.g., according to training procedures or regulations) based on the sensor data. For example, the computing device may receive sensor data indicating the user did not appropriately utilize fall protection equipment (e.g., did not clip a virtual fall-arrestive device, such as a self-retracting lifeline, to a support structure) within a virtual construction site. The computing devices outputs feedback (e.g., graphical, audio, or tactile) indicating whether the user performed the task appropriately. For example, in response to determining that the user did not utilize fall protection appropriately utilize the fall protection equipment, the computing device may output a graphical user interface representing a fall from a height.

In this way, a VR system may present various virtual training environments to a user to simulate real world work environments. By training a user in a virtual training environment, the VR system may enable a user to practice selecting and utilizing PPE before entering a real world environment. Utilizing a virtual environment may increase the amount of training a user can receive, which may improve worker safety when working in a real world environment. Further, utilizing a virtual environment may enable a worker to learn from mistakes without experiencing harm that would otherwise be caused by making mistakes in the real world. In this way, the VR system may improve worker safety in real world work environments by reducing or preventing safety events.

In yet another example, a computing device includes a memory and one or more processors coupled to the memory. The one or more processors are configured to output, for display by a display device, a first graphical user interface, wherein the first graphical user interface includes a plurality of graphical elements associated with a respective training module of a plurality of training modules, wherein each training module represents a respective training environment associated with one or more articles of personal protective equipment. The computing device may determine, based on first sensor data output by the one or more sensors, a selection of a graphical element of the plurality of graphical elements, the graphical element associated with a particular training module of the plurality of training modules; and output, for display by the display device, a second graphical user interface, wherein the second graphical user interface corresponds to the particular training module. The computing device may also execute the particular training module.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a block diagram illustrating an example computing system that includes a worker safety management system (WSMS) for managing safety of workers within a work environment in which augmented or virtual reality display devices of the workers provide enhanced safety information, in accordance with various techniques of this disclosure.

FIG. 2 is a block diagram providing an operating perspective of WSMS when hosted as a cloud-based platform capable of supporting multiple, distinct work environments having an overall population of workers equipped with augmented reality display devices, in accordance with various techniques of this disclosure.

FIG. 3 is a block diagram illustrating an example virtual reality system, in accordance with various techniques of this disclosure.

FIG. 4 is a block diagram illustrating an example virtual reality display device configured to present a virtual work environment, in accordance with various techniques of this disclosure.

FIGS. 5A-5G depict example VR graphical user interfaces, in accordance with some techniques of this disclosure.

FIG. 6 is a flow diagram illustrating an example technique of presenting virtual training environments via a virtual display device, in accordance with various techniques of the disclosure.

It is to be understood that the examples may be utilized and structural changes may be made without departing from the scope of the invention. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure describes techniques for training workers on personal protective equipment to be utilized in hazardous work environments. A worker in a real world, physical work environment may be exposed to various hazards or safety events (e.g., air contamination, heat, falls, etc.). The worker may utilize personal protective equipment (PPE) to reduce the risk of safety events.

According to aspects of this disclosure, a virtual reality (VR) system may be configured to present virtual training environments to a worker prior to the worker entering a physical work environment. The VR system may include various training modules corresponding to various tasks and/or training environments. Responsive to selecting a training module, the VR system may output, via a VR display device, a virtual environment corresponding to a real world, physical work environment. For example, the VR system may teach users to identify whether a worker is utilizing appropriate PPE for a work environment, select appropriate PPE for a work environment, utilize PPE correctly, or a combination therein. In some examples, the VR system presents graphical user interfaces corresponding to virtual work environments and provides feedback as a user interacts with the virtual work environment.

For example, the VR system may include one or more sensors configured to detect user movements as the user interacts with the virtual environment. The VR system may determine whether the user performs a task appropriately (e.g., according to training procedures or regulations) based on sensor data received from the sensors. For example, the VR system may output a graphical user interface representing a number of virtual PPE and a notification instructing the worker to select appropriate PPE for a given task. The VR system may receive sensor data indicative of the users' movements and determine whether the worker selected the appropriate virtual PPE based on the sensor movement.

The VR system outputs feedback (e.g., graphical, audio, or tactile) indicating whether the user performed the task appropriately. For example, the VR system may output a visual and/or audio data indicating the appropriate PPE (e.g., and an explanation of why such PPE is appropriate) in response to determining that the user did not select the appropriate PPE.

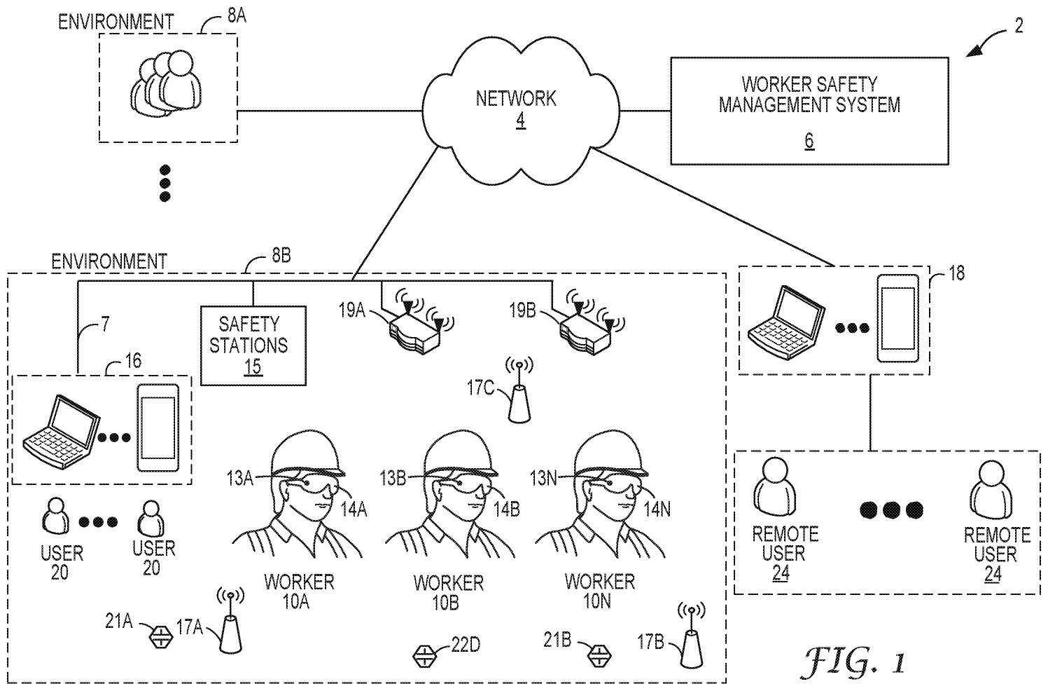

In this way, VR system may present various virtual training environments to a user to simulate real world work environments. In this way, the VR system may improve worker safety in real world, physical work environments (e.g., illustrated in FIG. 1) by reducing or preventing safety events when the worker enters a physical work environment.

FIG. 1 is a block diagram illustrating an example computing system 2 that includes a worker safety management system (WSMS) 6 for managing safety of workers 10A-10N (collectively, “workers 10”) within work environment 8A, 8B (collectively, “work environment 8”), in accordance with various techniques of this disclosure. As described herein, WSMS 6 provides information related to safety events, potential hazards, workers 10, machines, or other information relating to work environment 8 to an article of PPE configured to present an augmented reality display, virtual reality display, or a mixed reality display, which are collected referred to as an (AVR) display. In other examples, one or more of workers 10 may utilize an AVR display separate from one or more PPEs worn by the worker. In this example, the article of PPE configured to present the AVR display will be described herein as “safety glasses” (e.g., safety glasses 14A-14N as illustrated in FIG. 1). In other examples, however, the article of PPE configured to present the AVR display may include additional or alternative articles of PPE, such as welding helmets, face masks, face shields, or the like. By interacting with WSMS 6, safety professionals can, for example, evaluate and view safety events, manage area inspections, worker inspections, worker health, and PPE compliance.

In general, WSMS 6 provides data acquisition, monitoring, activity logging, reporting, predictive analytics, PPE control, generation and maintenance of data for controlling AVR overlay presentation and visualization, and alert generation. For example, WSMS 6 includes an underlying analytics and worker safety management engine and alerting system in accordance with various examples described herein. In general, a safety event may refer to an environmental condition (e.g., which may be hazardous), activities of a user of PPE, a condition of an article of PPE, or another event which may be harmful to the safety and/or health of a worker. In some examples, a safety event may be an injury or worker condition, workplace harm, a hazardous environmental condition, or a regulatory violation. For example, in the context of fall protection equipment, a safety event may be misuse of fall protection equipment, a user of the fall equipment experiencing a fall, or a failure of the fall protection equipment. In the context of a respirator, a safety event may be misuse of the respirator, a user of the respirator not receiving an appropriate quality and/or quantity of air, or failure of the respirator. A safety event may also be associated with a hazard in the environment in which the PPE is located, such as, for example, poor air quality, presence of a contaminant, a status of a machine or piece of equipment, a fire, or the like.

As further described below, WSMS 6 provides an integrated suite of worker safety management tools and implements various techniques of this disclosure. That is, WSMS 6 provides an integrated, end-to-end system for managing worker safety, within one or more physical work environments 8, which may be construction sites, mining or manufacturing sites, or any physical environment. The techniques of this disclosure may be realized within various parts of system 2.

As shown in the example of FIG. 1, system 2 represents a computing environment in which a computing device within of a plurality of physical work environments 8 electronically communicate with WSMS 6 via one or more computer networks 4. Each of work environment 8 represents a physical environment in which one or more individuals, such as workers 10, utilize PPE while engaging in tasks or activities within the respective environment.

In this example, environment 8A is shown as generally as having workers 10, while environment 8B is shown in expanded form to provide a more detailed example. In the example of FIG. 1, a plurality of workers 10A-10N are shown as utilizing respective safety glasses 14A-14N (collectively, “safety glasses 14”). In accordance with the techniques of the disclosure, safety glasses 14 are configured to present an AVR display of a field of view of the work environment that worker 10 is seeing through the respective safety glasses 14.

That is, safety glasses 14 are configured to present at least a portion of the field of view of the respective worker 10 through safety glasses 14 as well as any information determined to be relevant to the field of view by WSMS 6 (e.g., one or more indicator images). For instance, safety glasses 14 may include a camera or another sensor configured to capture the field of view (or information representative of the field of view) in real time or near real time. In some examples, the captured field of view and/or information representative of the field of view may be sent to WSMS 6 for analysis. In other examples, data indicating a position and orientation information (i.e., a pose) associated with the field of view may be communicated to WSMS 6. Based on the particular field of view of the safety glasses 14 (e.g., as determined from the position and orientation data), WSMS 6 may determine additional information pertaining to the current field of view of the worker 10 for presentation to the user. In some examples, the information relating to the field of view may include potential hazards, safety events, machine or equipment information, navigation information, instructions, diagnostic information, information about other workers 10, information relating to a job task, information related to one or more articles of PPE, or the like within the field of view. If WSMS 6 determines information relevant to the worker's field of view, WSMS 6 may generate one or more indicator images related to the determined information. For instance, WSMS 6 may generate a symbol, a notification or alert, a path, a list, or another indicator image that can be used as part of the AVR display via safety glasses 14. WSMS 6 may send the indicator images, or an AVR display including the one or more indicator images, to safety glasses 14 for display. In other examples, WSMS 6 outputs data indicative of the additional information, such as an identifier of the information as well as a position within the view for rendering the information, thereby instructing safety glasses 14 to construct the composite image to be presented by the AVR display. Safety glasses 14 may then present an enhanced AVR view to worker 10 on the AVR display.

In this way, the AVR display may include a direct or indirect live view of the real, physical work environment 8B as well as augmented computer-generated information. The augmented computer-generated information may be overlaid on the live view (e.g., field of view) of work environment 8B. In some cases, the computer-generated information may be constructive to the live field of view (e.g., additive to the real-world work environment 8B). Additionally, or alternatively, the computer-generated information may be destructive to the live field of view (e.g., masking a portion of the real-world field of view). In some examples, the computer-generated information is displayed as an immersive portion of the real work environment 8B. For instance, the computer-generated information may be spatially registered with the components within the field of view. In some such examples, worker 10 viewing work environment 8B via the AVR display of safety glasses 14 may have an altered perception of work environment 8B. In other words, the AVR display may present the computer-generated information as a cohesive part of the field of view such that the computer-generated information may seem like an actual component of the real-world field of view. Moreover, the image data for rendering by the AVR display may be constructed locally by components within safety glasses 14 in response to data and commands received from WSMS 6 identifying and positioning the AVR elements within the view. Alternatively, all or portions of the image data may be constructed remotely.

As further described herein, each of safety glasses 14 may include embedded sensors or monitoring devices and processing electronics configured to capture data in real-time as a user (e.g., worker) engages in activities while wearing safety glasses 14. For example, safety glasses 14 may include one or more sensors for sensing a field of view of worker 10 wearing the respective safety glasses 14. In some such examples, safety glasses 14 may include a camera to determine the field of view of worker 10. For instance, the camera may be configured to determine a live field of view that worker 10 is seeing in real time or near real time while looking through safety glasses 14.

In addition, each of safety glasses 14 may include one or more output devices for outputting data that is indicative of information relating to the field of view of worker 10. For example, safety glasses 14 may include one or more output devices to generate visual feedback, such as the AVR display. In some such examples, the one or more output devices may include one or more displays, light emitting diodes (LEDs), or the like. Additionally, or alternatively, safety glasses 14 may include one or more output devices to generate audible feedback (e.g., one or more speakers), tactile feedback (e.g., a device that vibrates or provides other haptic feedback), or both. In some examples, safety glasses 14 (or WSMS 6) may be communicatively coupled to one or more other articles of PPE configured to generate visual, audible, and/or tactile feedback.

In general, each of work environments 8 include computing facilities (e.g., a local area network) by which safety glasses 14 are able to communicate with WSMS 6. For example, work environments 8 may be configured with wireless technology, such as 802.11 wireless networks, 802.15 ZigBee networks, or the like. In the example of FIG. 1, environment 8B includes a local network 7 that provides a packet-based transport medium for communicating with WSMS 6 via network 4. In addition, environment 8B includes a plurality of wireless access points 19A, 19B (collectively, “wireless access points 19”) that may be geographically distributed throughout the environment to provide support for wireless communications throughout work environment 8B.

Each of safety glasses 14 is configured to communicate data, such as captured field of views, data, events, conditions, and/or gestures via wireless communications, such as via 802.11 Wi-Fi protocols, Bluetooth protocol or the like. Safety glasses 14 may, for example, communicate directly with a wireless access point 19. As another example, each worker 10 may be equipped with a respective one of wearable communication hubs 13A-13N (collectively, “communication hubs 13”) that enable and facilitate communication between safety glasses 14 and WSMS 6. For example, safety glasses 14 as well as other PPEs (such as fall-arrestive devices, hearing protection, hardhats, or other equipment) for the respective worker 10 may communicate with a respective communication hub 13 via Bluetooth or other short range protocol, and communication hubs 13 may communicate with PPEMs 6 via wireless communications processed by wireless access points 19. In some examples, as illustrated in FIG. 1, communication hubs 13 may be a component of safety glasses 14. In other examples, communication hubs 13 may be implemented as wearable devices, stand-alone devices deployed within environment 8B, or a component of a different article of PPE.

In general, each of communication hubs 13 operates as a wireless device for safety glasses 14 relaying communications to and from safety glasses 14, and may be capable of buffering data in case communication is lost with WSMS 6. Moreover, each of communication hubs 13 is programmable via WSMS 6 so that local rules may be installed and executed without requiring a connection to the cloud. As such, each of communication hubs 13 may provide a relay of streams of data (e.g., data representative of a field of view) from safety glasses 14 within the respective environment 8B, and provides a local computing environment for localized determination of information relating to the field of view based on streams of events in the event communication with WSMS 6 is lost.

As shown in the example of FIG. 1, environment 8B may also include one or more wireless-enabled beacons 17A-17C (collectively, “beacons 17”) that provide accurate location information within work environment 8B. For example, beacons 17 may be GPS-enabled such that a controller within the respective beacon 17 may be able to precisely determine the position of the respective beacon 17. Based on wireless communications with one or more of beacons 17, a given pair of safety glasses 14 or communication hub 13 worn by a worker 10 may be configured to determine a location of the worker 10 within work environment 8B. In this way, data relating to the field of view of the worker 10 reported to WSMS 6 may be stamped with positional information to aid analysis, reporting, and analytics performed by WSMS 6.

In addition, environment 8B may also include one or more wireless-enabled sensing stations 21A, 21B (collectively, “sensing stations 21”). Each sensing station 21 includes one or more sensors and a controller configured to output data indicative of sensed environmental conditions. Moreover, sensing stations 21 may be positioned within respective geographic regions of environment 8B or otherwise interact with beacons 17 to determine respective positions and include such positional information when reporting environmental data to WSMS 6. As such, WSMS 6 may be configured to correlate the sensed environmental conditions with the particular regions and, therefore, may utilize the captured environmental data when processing field of view data received from safety glasses 14. For example, WSMS 6 may utilize the environmental data to aid in determining relevant information relating to the field of view (e.g., for presentation on the AVR display), generating alerts, providing instructions, and/or performing predictive analytics, such as determining any correlations between certain environmental conditions (e.g., heat, humidity, visibility) with abnormal worker behavior or increased safety events. As such, WSMS 6 may utilize current environmental conditions to aid in generation of indicator images for the AVR display, notify workers 10 of the environmental conditions or safety events, as well as aid in the prediction and avoidance of imminent safety events. Example environmental conditions that may be sensed by sensing stations 21 include but are not limited to temperature, humidity, presence of gas, pressure, visibility, wind, or the like.

In some examples, environment 8B may include one or more safety stations 15 distributed throughout the environment to provide viewing stations for accessing safety glasses 14. Safety stations 15 may allow one of workers 10 to check out safety glasses 14 and/or other safety equipment, verify that safety equipment is appropriate for a particular one of environments 8, and/or exchange data. For example, safety stations 15 may transmit alert rules, software updates, or firmware updates to safety glasses 14 or other equipment. Safety stations 15 may also receive data cached on safety glasses 14, communication hubs 13, and/or other safety equipment. That is, while safety glasses 14 (and/or communication hubs 13) may typically transmit data representative of the field of views of a worker 10 wearing safety glasses 14 to network 4 in real time or near real time, in some instances, safety glasses 14 (and/or communication hubs 13) may not have connectivity to network 4. In such instances, safety glasses 14 (and/or communication hubs 13) may store field of view data locally and transmit the data to safety stations 15 upon being in proximity with safety stations 15. Safety stations 15 may then upload the data from safety glasses 14 and connect to network 4.

In addition, each of environments 8 include computing facilities that provide an operating environment for end-user computing devices 16 for interacting with WSMS 6 via network 4. For example, each of environments 8 typically includes one or more safety managers responsible for overseeing safety compliance within the environment 8. In general, each user 20 may interact with computing devices 16 to access WSMS 6. Similarly, remote users 24 may use computing devices 18 to interact with WSMS 6 via network 4. For purposes of example, the end-user computing devices 16 may be laptops, desktop computers, mobile devices, such as tablets or so-called smart phones, or the like.

Users 20, 24 may interact with WSMS 6 to control and actively manage many aspects of worker safety, such as accessing and viewing field of view data, determination of information relating to the field of views, analytics, and/or reporting. For example, users 20, 24 may review information acquired, determined, and/or stored by WSMS 6. In addition, users 20, 24 may interact with WSMS 6 to update worker training, input a safety event, provide task lists for workers, or the like.

Further, as described herein, WSMS 6 integrates an event processing platform configured to process thousand or even millions of concurrent streams of events from digitally enabled PPEs, such as safety glasses 14. An underlying analytics engine of WSMS 6 may apply historical data and models to the inbound streams to determine information relevant to a field of view of a worker 10, such as predicted occurrences of safety events, vicinity of workers 10 to a potential hazard, behavioral patterns of the worker 10, or the like. Further, WSMS 6 provides real time alerting and reporting to notify workers 10 and/or users 20, 24 of any potential hazards, safety events, anomalies, trends, or other information may be useful to worker 10 viewing a specific area of work environment 8B via the AVR display. The analytics engine of WSMS 6 may, in some examples, apply analytics to identify relationships or correlations between sensed field of views, environmental conditions, geographic regions, and other factors and analyze whether to provide one or more indicator images to worker 10 via the AVR display about the respective field of view.

In this way, WSMS 6 tightly integrates comprehensive tools for managing worker safety with an underlying analytics engine and communication system to provide data acquisition, monitoring, activity logging, reporting, behavior analytics, and alert generation. Moreover, WSMS 6 provides a communication system for operation and utilization by and between the various elements of system 2. Users 20, 24 may access WSMS 6 to view results on any analytics performed by WSMS 6 on data acquired from workers 10. In some examples, WSMS 6 may present a web-based interface via a web server (e.g., an HTTP server) or client-side applications may be deployed for devices of computing devices 16, 18 used by users 20, 24, such as desktop computers, laptop computers, mobile devices, such as smartphones and tablets, or the like.

In some examples, WSMS 6 may provide a database query engine for directly querying WSMS 6 to view acquired safety information, compliance information, and any results of the analytic engine, e.g., by the way of dashboards, alert notifications, reports or the like. That is, users 24, 26, or software executing on computing devices 16, 18, may submit queries to WSMS 6 and receive data corresponding to the queries for presentation in the form of one or more reports or dashboards. Such dashboards may provide various insights regarding system 2, such as identifications of any geographic regions within environments 2 for which unusually anomalous (e.g., high) safety events have been or are predicted to occur, identifications of any of environments 2 exhibiting anomalous occurrences of safety events relative to other environments, PPE compliance of workers, potential hazards indicated by workers 10, or the like.

As illustrated in detail below, WSMS 6 may simplify managing worker safety. That is, the techniques of this disclosure may enable active safety management and allow an organization to take preventative or correction actions with respect to certain regions within environments 8, potential hazards, particular pieces of safety equipment, or individual workers 10, define and may further allow the entity to implement workflow procedures that are data-driven by an underlying analytical engine. Further example details of PPEs and worker safety management systems having analytical engines for processing streams of data are described in PCT Patent Application PCT/US2017/039014, filed Jun. 23, 2017, U.S. application Ser. No. 15/190,564, filed Jun. 23, 2016 and U.S. Provisional Application 62/408,634 filed Oct. 14, 2016, the entire content of each of which are hereby expressly incorporated by reference herein.

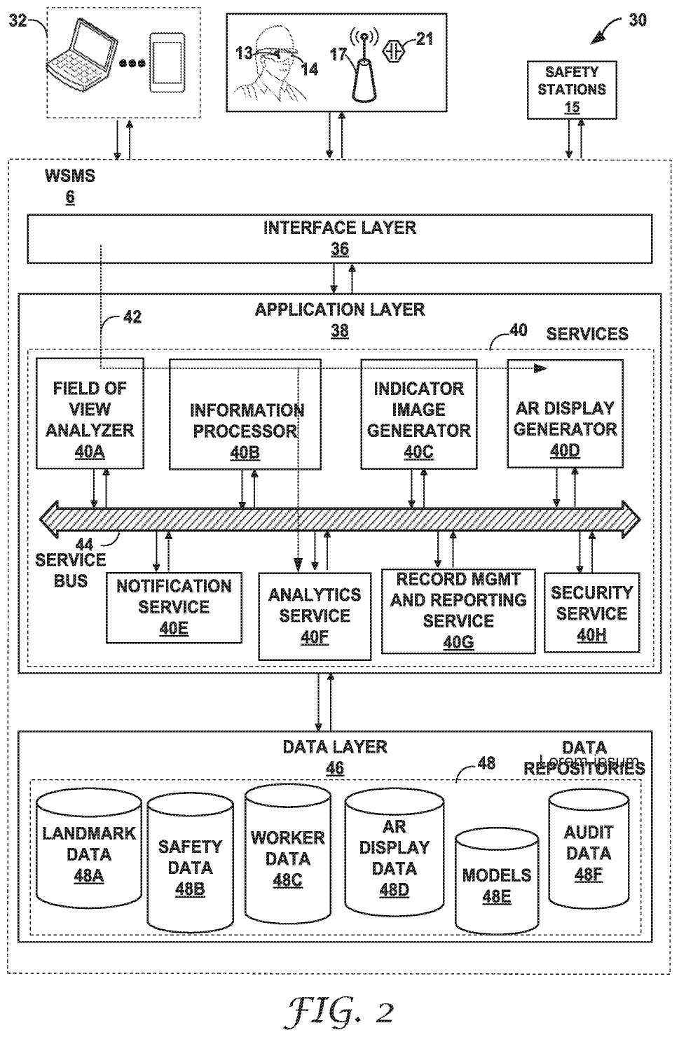

FIG. 2 is a block diagram providing an operating perspective of WSMS 6 when hosted as a cloud-based platform capable of supporting multiple, distinct work environments 8 having an overall population of workers 10 equipped with safety glasses 14, in accordance with various techniques of this disclosure. In the example of FIG. 2, the components of WSMS 6 are arranged according to multiple logical layers that implement the techniques of the disclosure. Each layer may be implemented by one or more modules and may include hardware, software, or a combination of hardware and software.

In some examples, computing devices 32, safety glasses 14, communication hubs 13, beacons 17, sensing stations 21, and/or safety stations 15 operate as clients 30 that communicate with WSMS 6 via interface layer 36. Computing devices 32 typically execute client software applications, such as desktop applications, mobile applications, and/or web applications. Computing devices 32 may represent any of computing devices 16, 18 of FIG. 1. Examples of computing devices 32 may include, but are not limited to, a portable or mobile computing device (e.g., smartphone, wearable computing device, tablet), laptop computers, desktop computers, smart television platforms, and/or servers.

In some examples, computing devices 32, safety glasses 14, communication hubs 13, beacons 17, sensing stations 21, and/or safety stations 15 may communicate with WSMS 6 to send and receive information (e.g., position and orientation) related to a field of view of workers 10, determination of information related to the field of view, potential hazards and/or safety events, generation of indicator images having enhanced AVR visualization and/or data for causing local generation of the indicator images by safety glasses 14, alert generation, or the like. Client applications executing on computing devices 32 may communicate with WSMS 6 to send and receive information that is retrieved, stored, generated, and/or otherwise processed by services 40. For example, the client applications may request and edit potential hazards or safety events, machine status, worker training, PPE compliance information, or any other information described herein including analytical data stored at and/or managed by WSMS 6. In some examples, client applications may request and display information generated by WSMS 6, such as an AVR display including one or more indicator images. In addition, the client applications may interact with WSMS 6 to query for analytics information about PPE compliance, safety event information, audit information, or the like. The client applications may output for display information received from WSMS 6 to visualize such information for users of clients 30. As further illustrated and described below, WSMS 6 may provide information to the client applications, which the client applications output for display in user interfaces.

Client applications executing on computing devices 32 may be implemented for different platforms but include similar or the same functionality. For instance, a client application may be a desktop application compiled to run on a desktop operating system, such as Microsoft Windows, Apple OS X, or Linux, to name only a few examples. As another example, a client application may be a mobile application compiled to run on a mobile operating system, such as Google Android, Apple iOS, Microsoft Windows Mobile, or BlackBerry OS to name only a few examples. As another example, a client application may be a web application such as a web browser that displays web pages received from WSMS 6. In the example of a web application, WSMS 6 may receive requests from the web application (e.g., the web browser), process the requests, and send one or more responses back to the web application. In this way, the collection of web pages, the client-side processing web application, and the server-side processing performed by WSMS 6 collectively provides the functionality to perform techniques of this disclosure. In this way, client applications use various services of WSMS 6 in accordance with techniques of this disclosure, and the applications may operate within different computing environments (e.g., a desktop operating system, mobile operating system, web browser, or other processors or processing circuitry, to name only a few examples).

As shown in FIG. 2, in some examples, WSMS 6 includes an interface layer 36 that represents a set of application programming interfaces (API) or protocol interface presented and supported by WSMS 6. Interface layer 36 initially receives messages from any of clients 30 for further processing at WSMS 6. Interface layer 36 may therefore provide one or more interfaces that are available to client applications executing on clients 30. In some examples, the interfaces may be application programming interfaces (APIs) that are accessible over network 4. In some example approaches, interface layer 36 may be implemented with one or more web servers. The one or more web servers may receive incoming requests, may process, and/or may forward information from the requests to services 40, and may provide one or more responses, based on information received from services 40, to the client application that initially sent the request. In some examples, the one or more web servers that implement interface layer 36 may include a runtime environment to deploy program logic that provides the one or more interfaces. As further described below, each service may provide a group of one or more interfaces that are accessible via interface layer 36.

In some examples, interface layer 36 may provide Representational State Transfer (RESTful) interfaces that use HTTP methods to interact with services and manipulate resources of WSMS 6. In such examples, services 40 may generate JavaScript Object Notation (JSON) messages that interface layer 36 sends back to the client application that submitted the initial request. In some examples, interface layer 36 provides web services using Simple Object Access Protocol (SOAP) to process requests from client applications. In still other examples, interface layer 36 may use Remote Procedure Calls (RPC) to process requests from clients 30. Upon receiving a request from a client application to use one or more services 40, interface layer 36 sends the information to application layer 38, which includes services 40.

As shown in FIG. 2, WSMS 6 also includes an application layer 38 that represents a collection of services for implementing much of the underlying operations of WSMS 6. Application layer 38 receives information included in requests received from client applications that are forwarded by interface layer 36 and processes the information received according to one or more of services 40 invoked by the requests. Application layer 38 may be implemented as one or more discrete software services executing on one or more application servers, e.g., physical or virtual machines. That is, the application servers provide runtime environments for execution of services 40. In some examples, the functionality of interface layer 36 as described above and the functionality of application layer 38 may be implemented at the same server.

Application layer 38 may include one or more separate software services 40 (e.g., processes) that may communicate via, for example, a logical service bus 44. Service bus 44 generally represents a logical interconnection or set of interfaces that allows different services to send messages to other services, such as by a publish/subscription communication model. For example, each of services 40 may subscribe to specific types of messages based on criteria set for the respective service. When a service publishes a message of a particular type on service bus 44, other services that subscribe to messages of that type will receive the message. In this way, each of services 40 may communicate information to one another. As another example, services 40 may communicate in point-to-point fashion using sockets or other communication mechanism. Before describing the functionality of each of services 40, the layers are briefly described herein.

Data layer 46 of WSMS 6 represents a data repository 48 that provides persistence for information in WSMS 6 using one or more data repositories 48. A data repository, generally, may be any data structure or software that stores and/or manages data. Examples of data repositories include but are not limited to relational databases, multi-dimensional databases, maps, and/or hash tables. Data layer 46 may be implemented using Relational Database Management System (RDBMS) software to manage information in data repositories 48. The RDBMS software may manage one or more data repositories 48, which may be accessed using Structured Query Language (SQL). Information in the one or more databases may be stored, retrieved, and modified using the RDBMS software. In some examples, data layer 46 may be implemented using an Object Database Management System (ODBMS), Online Analytical Processing (OLAP) database, or any other suitable data management system.

As shown in FIG. 2, each of services 40A-40H is implemented in a modular form within WSMS 6. Although shown as separate modules for each service, in some examples the functionality of two or more services may be combined into a single module or component. Each of services 40 may be implemented in software, hardware, or a combination of hardware and software. Moreover, services 40 may be implemented as standalone devices, separate virtual machines or containers, processes, threads, or software instructions generally for execution on one or more physical processors or processing circuitry.

In some examples, one or more of services 40 may each provide one or more interfaces 42 that are exposed through interface layer 36. Accordingly, client applications of computing devices 32 may call one or more interfaces 42 of one or more of services 40 to perform techniques of this disclosure.

In some cases, services 40 include a field of view analyzer 40A used to identify a field of view of environment 8B a worker 10 is viewing through safety glasses 14. For example, field of view analyzer 40A may receive current pose information (position and orientation), images, a video, or other information representative of the field of view from a client 30, such as safety glasses 14, and may read information stored in landmark data repository 48A to identify the field of view. In some examples, landmark data repository 48A may represent a 3D map of positions and identifications of landmarks within the particular work environment. In some examples, this information can be used to identify where worker 10 may be looking within work environment 8B, such as by performing Simultaneous Localization and Mapping (SLAM) for vision-aided inertial navigation (VINS). For instance, landmark data repository 48A may include identifying features, location information, or the like relating to machines, equipment, workers 10, buildings, windows, doors, signs, or anything other components within work environment 8B that may be used to identify the field of view. In other examples, data from one or more global positioning sensors (GPS) and accelerometers may be sent to field of view analyzer 40 by safety glasses 14 for determining the position and orientation of the worker as the work traverses the work environment. In some examples, position and orientation tracking may be performed by vision and inertial data, GPS data, and/or combinations thereof, and may be performed locally by estimation components within safety glasses 14 and/or remotely by field of view analyzer 40A of WSMS 6.

In some examples, field of view analyzer 40A may use additional or alternative information, such as a location of worker 10, a job site within work environment 8B worker 10 is scheduled to work at, sensing data of other articles of PPE, or the like to identify the field of view of the worker 10. For example, in some cases, safety glasses 14 may include one or more components configured to determine a GPS location, direction or orientation, and/or elevation of safety glasses 14 to determine the field of view. In some such cases, landmark data repository 48A may include respective locations, directions or orientations, and/or elevations of components of work environment 8B, and may use the locations, directions or orientations, and/or elevations of the components to determine what is in the field of view of worker 10 based on GPS location, direction or orientation, and/or elevation of safety glasses 14.

In some examples, field of view analyzer 40A may process the received images, video, or other information representative of the field of view to include information in the same form as the landmark information stored in landmark data repository 48A. For example, field of view analyzer 40A may analyze an image or a video to extract data and/or information that is included in landmark data repository 48A. As one example, field of view analyzer 40A may extract data representative of specific machines and equipment within an image or video to compare to data stored in landmark data repository 48A.

In some examples, work environment 8B may include tags or other identification information throughout work environment 8B, and field of view analyzer 40A may extract such information from the received images, videos, and/or data to determine the field of view. For example, work environment 8B may include a plurality of quick response (QR) codes distributed throughout the work environment 8B, and field of view analyzer 40A may determine one or more QR codes within the received field of view and compare to corresponding QR codes stored in landmark data repository 48A to identify the field of view. In other examples, different tags or identifying information other than QR codes may by distributed throughout work environment 8B.

Field of view analyzer 40A may also be able to identify details about a worker 10, an article of PPE worn by a worker 10, a machine, or another aspect of the field of view. For example, field of view analyzer 40A may be able to identify a brand, a model, a size, or the like of an article of PPE worn by a worker 10 within the field of view. As another example, field of view analyzer 40A may be able to determine a machine status of a machine within the field of view. The identified details may be saved in at least one of landmark data repository 48A, safety data repository 48B, or worker data repository 48C, may be sent to information processor 40B, or both. Field of view analyzer 40A may further create, update, and/or delete information stored in landmark data 48A, safety data repository 48B, and/or worker data repository 48C.

Field of view analyzer 40A may also be able to detect and/or identify one or more gestures by worker 10 within the field of view. Such gestures may be performed by worker 10 for various reasons, such as, for example, to indicate information about the field of view to WSMS 6, adjust user settings, generate one or more indicator images, request additional information, or the like. For instance, worker 10 may perform a specific gesture to indicate the presence of a safety event within the field of view that may not be indicated with an indicator image. As another example, worker 10 may use a gesture in order to silence or turn-off one or more functions of the AVR display, such as, one or more indicator images. Gesture inputs and corresponding functions of WSMS 6 and/or safety glasses may be stored in any of landmark data 48A, safety data repository 48B, and/or worker data repository 48C.

Field of view analyzer 40A may be configured to continuously identify the field of view of safety glasses 14. For example, field of view analyzer 40A may continuous determine fields of views as worker 10 is walking or moving through work environment 8B. In this way, WSMS 6 may continuously generate and update indicator images, AVR displays, or other information that is provided to worker 10 via safety glasses 14 in real time or near real-time.

Information processor 40B determines information relating to the field of view determined by field of view analyzer 40A. For example, as described herein, information processor 40B may determine potential hazards, safety events, presence of workers 10, machine or equipment statuses, PPE information, location information, instructions, task lists, or other information relating to the field of view. For instance, information processor 40B may determine potential hazards and safety events within the field of view.

Information processor 40B may read such information from safety data repository 48B and/or worker data repository 48C. For example, safety data repository 48B may include data relating to recorded safety events, sensed environmental conditions, worker indicated hazards, machine or equipment statuses, emergency exit information, safe navigation paths, proper PPE use instructions, service life or condition of articles of PPE, horizon or ground level indicators, boundaries, hidden structure information, or the like. Worker data repository 48C may include identification information of workers 10, PPE required for workers 10, PPE required for various work environments 8, articles of PPE that workers 10 have been trained to use, information pertaining to various sizes of one or more articles of PPE for workers 10, locations of workers, paths workers 10 have followed, gestures or annotations input by workers 10, machine or equipment training of workers 10, location restrictions of workers 10, task lists for specific workers 10, PPE compliance information of workers 10, physiological information of workers 10, motions of workers 10, or the like. In some examples, information processor 40B may be configured to determine a severity, ranking, or priority of information within the field of view.

Information processor 40B may further create, update, and/or delete information stored in safety data repository 48B and/or worker data repository 48C. For example, information processor 40B may update worker data repository 48C after a worker 10 undergoes training for one or more articles of PPE, or information processor 40B may delete information in worker data repository 48C if a worker 10 has outdated training on one or more articles of PPE. As another example, information processor 40B may update or delete a safety event in safety data repository 48B upon detection or conclusion, respectively, of the safety event. In other examples, information processor 40B may create, update, and/or delete information stored in safety data repository 48B and/or in worker data repository 48C due to additional or alternative reasons.

Moreover, in some examples, such as in the example of FIG. 2, a safety manager may initially configure one or more rules pertaining to information that is relevant to a field of view. As such, remote user 24 may provide one or more user inputs at computing device 18 that configure a set of rules relating to field of views and/or work environment 8B. For example, computing device 32 of the safety manager may send a message that defines or specifies the one or more articles of PPE required for a specific job function, for a specific environment 8, for a specific worker 10A, or the like. As another example, computing device 32 of the safety manager may send a message that defines or specifies when certain information should be determined to pertain to the field of view. For instance, the message may define or specify a distance threshold that a worker 10 is from a safety event or potential hazard in which the safety event or potential hazard becomes relevant to the field of view. Such messages may include data to select or create conditions and actions of the rules. As yet another example, computing device 32 of the safety manager may send a message that defines or specifies severities, rankings, or priorities of different types of information relating to the field of view. WSMS 6 may receive the message at interface layer 36 which forwards the message to information processor 40B, which may additionally be configured to provide a user interface to specify conditions and actions of rules, receive, organize, store, and update rules included in safety data repository 48B and/or worker data repository 48C, such as rules indicating what information is relevant to a field of view in various cases.

In some examples, storing the rules may include associating a rule with context data, such that information processor 40B may perform a lookup to select rules associated with matching context data. Context data may include any data describing or characterizing the properties or operation of a worker, worker environment, article of PPE, or any other entity. In some examples, the context data (or a portion of context data) may be determined based on the field of view identified by field of view analyzer 40A. Context data of a worker may include, but is not limited to, a unique identifier of a worker, type of worker, role of worker, physiological or biometric properties of a worker, experience of a worker, training of a worker, time worked by a worker over a particular time interval, location of the worker, or any other data that describes or characterizes a worker. Context data of an article of PPE may include, but is not limited to, a unique identifier of the article of PPE; a type of PPE of the article of PPE; a usage time of the article of PPE over a particular time interval; a lifetime of the PPE; a component included within the article of PPE; a usage history across multiple users of the article of PPE; contaminants, hazards, or other physical conditions detected by the PPE, expiration date of the article of PPE; operating metrics of the article of PPE; size of the PPE; or any other data that describes or characterizes an article of PPE. Context data for a work environment may include, but is not limited to, a location of a work environment, a boundary or perimeter of a work environment, an area of a work environment, hazards within a work environment, physical conditions of a work environment, permits for a work environment, equipment within a work environment, owner of a work environment, responsible supervisor and/or safety manager for a work environment; or any other data that describes or characterizes a work environment.

In general, indicator image generator 40C operates to control display of enhanced AVR information by AVR display 12 of safety glasses 14. In one example, indicator image generator 40C generates one or more indicator images (overlay image data) related to the information relevant to the field of view as determined by information processor 40B and communicates the overlay images to safety glasses 14. In other examples, indicator image generator 40C communicates commands that cause safety glasses 14 to locally render an AVR element on a region of the AVR display. As one example implementation, indicator image generator 40C installs and maintains a database (e.g., a replica of all or a portion of AVR display data 48D, described below) within safety glasses 14 and outputs commands specifying an identifier and a pixel location for each AVR element to be rendered. Responsive to the commands, safety glasses 14 generates image data for presenting the enhanced AVR information to the worker via AVR display 12.

As examples, the one or more indicator images may include a symbol (e.g., a hazard sign, a check mark, an X, an exclamation point, an arrow, or another symbol), a list, a notification or alert, an information box, a status indicator, a path, a ranking or severity indicator, an outline, a horizon line, an instruction box, or the like. In any case, the indicator images may be configured to direct a worker's attention to or provide information about an object within the field of view or a portion of the field of view. For example, the indicator images may be configured to highlight a safety event, a potential hazard, a safe path, an emergency exit, a machine or piece of equipment, an article of PPE, PPE compliance of a worker, or any other information as described herein.

Indicator image generator 40C may read information from AVR display data repository 48D to generate the indicator images or otherwise generate the commands for causing the display of the indicator images. For example, AVR display data repository 48D may include previously stored indicator images, which may be understood as graphical elements also referred to herein as AVR elements, and may store unique identifiers associated with each graphical element. Thus, indicator image generator 40C may be able to access a previously stored indicator image from AVR display data repository 48D, which may enable indicator image generator 40C to generate the one or more indicator images using a previously stored indicator image and/or by modifying a previously stored indicator image. Additionally, or alternatively, indicator image generator 40C may render one or more new indicator images rather than using or modifying a previously stored indicator image.

In some examples, indicator image generator 40C may also generate, or cause to be generated, animated or dynamic indicator images. For example, indicator image generator 40C may generate flashing, color-changing, moving, or indicator images that are animated or dynamic in other ways. In some cases, a ranking, priority, or severity of information to be indicated by an indicator image may be factored into the generation of the indicator image. For instance, if information processor 40B determines a first safety event within the field of view is more severe than a second safety event within the field of view, indicator image generator 40C may generate a first indicator image that is configured to draw more attention to the first safety event than the indicator image for the second safety event (e.g., a flashing indicator image in comparison to a static indicator image).

Indicator image generator 40C may further create, update, and/or delete information stored in AVR display data repository 48D. For example, indicator image generator 40C may update AVR display data repository 48D to include one or more rendered or modified indicator images. In other examples, indicator image generator 40C may create, update, and/or delete information stored in AVR display data repository 48D to include additional and/or alternative information.

In some examples, WSMS 6 includes an AVR display generator 40D that generates the AVR display. As described above, in other examples, all or at least a portion of the AVR display may be generated locally by safety glasses 14 in response to commands from WSMS 6 in a manner similar to the examples described herein. In some examples, AVR display generator 40D generates the AVR display including at least the one or more indicator images generated by indicator image generator 40C. For example, AVR display generator 40D may be configured to arrange the one or more indicator images in a configuration based on the determined field of view such that the one or more indicator images overlay and/or obscure the desired portion of the field of view. For example, AVR display generator 40D may generate an AVR display including an indicator image for a safety event in a specific location such that the indicator image is overlaid on the safety event within the field of view when presented to worker 10 via safety glasses 14. AVR display generator 40D may additionally, or alternatively, obscure a portion of the view of view.

In some examples, AVR display generator 40D may generate (or cause to be generated locally) a plurality of AVR displays for the field of view. In some such cases, a worker 10 may be able to interact with one or more of the AVR displays. For example, AVR display generator 40D may generate an AVR display that indicates a worker in the field of view is not properly equipped with PPE, and the worker 10 may be able to interact with the AVR display (e.g., as seen through safety glasses 14) to request additional information about the worker not properly equipped with PPE. For instance, the worker 10 may be able to complete a gesture in the field of view that results in a second AVR display being presented via safety glasses 14. The second display may include an information box as an indicator image to provide details with respect to the improper or missing PPE of the worker in the field of view. Thus, AVR display generator 40D may generate both the first AVR display that includes the indicator image signifying that the worker is not properly equipped with PPE and the second AVR display that includes additional information relating the worker's PPE. As another example, AVR display generator 40D may generate a first AVR display including a task list, and one or more additional AVR displays that include tasks marked off as indicated by a gesture of the worker within the field of view.

In some cases, AVR display generator 40D may use information stored in AVR display data repository 48D to generate the AVR display (or cause the AVR display to be generated locally by safety glasses 14). For example, AVR display generator 40D may use or modify a stored arrangement of an AVR display for a similar or the same field of view as determined by field of view analyzer 40A. Moreover, AVR display generator 40D may further create, update, and/or delete information stored in AVR display data repository 48D. For example, AVR display generator 40D may update AVR display data repository 48D to include arranged displays of one or more indicator images, alone or including a portion of the field of view. In other examples, AVR display generator 40D may create, update, and/or delete information stored in AVR display data repository 48D to include additional and/or alternative information.

AVR display generator 40D may send the generated AVR displays to safety glasses 14 for presentation. For example, AVR display generator 40D may send an AVR display including an arrangement of one or more indicator images to be overlaid on the field of view seen through safety glasses 14. As another example, AVR display generator 40D may send a generated AVR display including both the arranged indicator images and at least a portion of the field of view.

In some examples, analytics service 40F performs in depth processing of data streams from the PPEs, the field of view, identified relevant information, generated AVR displays, or the like. Such in depth processing may enable analytics service 40F to determine PPE compliance of workers 10, presence of safety events or potential hazards, more accurately identify the fields of view, more accurately identify gestures of a worker, identify worker preferences, or the like.

As one example, PPEs and/or other components of the work environment may be fitted with electronic sensors that generate streams of data regarding status or operation of the PPE, environmental conditions within regions of the work environment, and the like. Analytics service 40F may be configured to detect conditions in the streams of data, such as by processing the streams of PPE data in accordance with one or more analytical models 48E. Based on the conditions detected by analytics service 40F and/or conditions reported or otherwise detected in a particular work environment, analytics service 40F may update AVR display data 48D to include indicators to be displayed to individuals (e.g., workers of safety managers) within the work environment in real-time or pseudo real-time based on the particular location and orientation of the augmented reality display device associated with the individual. In this way, AVR information displayed via safety glasses 14 may be controlled in real-time, closed-loop fashion in response to analytical processing of streams of data from PPEs and other sensors collocated with a particular work environment.

In some cases, analytics service 40F performs in depth processing in real-time to provide real-time alerting and/or reporting. In this way, analytics service 40F may be configured as an active worker safety management system that provides real-time alerting and reporting to a safety manager, a supervisor, or the like in the case of PPE non-compliance of a worker 10, a safety event or potential hazard, or the like. This may enable the safety manager and/or supervisor to intervene such that workers 10 are not at risk for harm, injury, health complications, or combinations thereof due to a lack of PPE compliance, a safety event or potential hazard, or the like.

In addition, analytics service 40F may include a decision support system that provides techniques for processing data to generate assertions in the form of statistics, conclusions, and/or recommendations. For example, analytics service 40F may apply historical data and/or models stored in models repository 48E to determine the accuracy of the field of view determined by field of view analyzer 40A, the relevant information determined by information processor 40B, the gestures determined by field of view analyzer 40A, and/or the AVR displays generated by AVR display generator 40D. In some such examples, analytics service 40F may calculate a confidence level relating to the accuracy of the field of view determined by field of view analyzer 40A, the relevant information determined by information processor 40B, the gestures determined by field of view analyzer 40A, and/or the AVR displays generated by AVR display generator 40D. As one example, in the case in which lighting conditions of work environment 8B may be reduced, the confidence level calculated by analytics service 40F for the identified field of view may be lower than a confidence level calculated when lighting conditions are not reduced. In some cases, if the calculated confidence level is less than or equal to a threshold confidence level, notification service 40E may present an alert (e.g., via safety glasses) to notify worker 10 that the results of the field of view identification may not be completely accurate. Hence, analytics service 40F may maintain or otherwise use one or more models that provide statistical assessments of the accuracy of the field of view determined by field of view analyzer 40A, the relevant information determined by information processor 40B, the gestures determined by field of view analyzer 40A, and/or the AVR displays generated by AVR display generator 40D. In one example approach, such models are stored in models repository 48E.

Analytics service 40F may also generate order sets, recommendations, and quality measures. In some examples, analytics service 40F may generate user interfaces based on processing information stored by WSMS 6 to provide actionable information to any of clients 30. For example, analytics service 40F may generate dashboards, alert notifications, reports, or the like for output at any of clients 30. Such information may provide various insights regarding baseline (“normal”) safety event occurrences, PPE compliance, worker productivity, or the like.

Moreover, analytics service 40F may use in depth process to more accurately identify the field of view, the relevant information related to the field of view, the gestures input by a worker, and/or the arrangement of indicator images for the AVR displays. For example, although other technologies can be used, analytics service 40F may utilize machine learning when processing data in depth. That is, analytics service 40F may include executable code generated by application of machine learning to identification of the field of view, relevant information related to the field of view, gestures input by a worker, and/or the arrangement of indicator images for the AVR displays, image analyzing, or the like. The executable code may take the form of software instructions or rule sets and is generally referred to as a model that can subsequently be applied to data generated by or received by WSMS 6 for detecting similar patterns, identifying the field of view, relevant information related to the field of view, gestures input by a worker, and/or the arrangement of indicator images for the AVR displays, image analyzing, or the like.

Analytics service 40F may, in some examples, generate separate models for each worker 10, for a particular population of workers 10, for a particular work environment 8, for a particular field of view, for a specific type of safety event of hazard, for a machine and/or piece of equipment, for a specific job function, or for combinations thereof, and store the models in models repository 48E. Analytics service 40F may update the models based on data received from safety glasses 14, communication hubs 13, beacons 17, sensing stations 21, and/or any other component of WSMS 6, and may store the updated models in models repository 48E. Analytics service 40F may also update the models based on statistical analysis performed, such as the calculation of confidence intervals, and may store the updated models in models repository 48E.

Example machine learning techniques that may be employed to generate models can include various learning styles, such as supervised learning, unsupervised learning, and semi-supervised learning. Example types of algorithms include Bayesian algorithms, Clustering algorithms, decision-tree algorithms, regularization algorithms, regression algorithms, instance-based algorithms, artificial neural network algorithms, deep learning algorithms, dimensionality reduction algorithms, or the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbour (kNN), Learning Vector Quantization (LUQ), Self-Organizing Map (SOM), Locally Weighted Learning (LWL), Ridge Regression, Least Absolute Shrinkage and Selection Operator (LASSO), Elastic Net, Least-Angle Regression (LAVRS), Principal Component Analysis (PCA), and/or Principal Component Regression (PCR).

Record management and reporting service 40G processes and responds to messages and queries received from computing devices 32 via interface layer 36. For example, record management and reporting service 40G may receive requests from client computing devices 32 for data related to individual workers, populations or sample sets of workers, and/or environments 8. In response, record management and reporting service 40G accesses information based on the request. Upon retrieving the data, record management and reporting service 40G constructs an output response to the client application that initially requested the information. In some examples, the data may be included in a document, such as an HTML document, or the data may be encoded in a JSON format or presented by a dashboard application executing on the requesting client computing device.

As additional examples, record management and reporting service 40G may receive requests to find, analyze, and correlate information over time. For instance, record management and reporting service 40G may receive a query request from a client application for safety events, potential hazards, worker-entered gestures, PPE compliance, machine status, or any other information described herein stored in data repositories 48 over a historical time frame, such that a user can view the information over a period of time and/or a computing device can analyze the information over the period of time.

In some examples, services 40 may also include security service 40H that authenticates and authorizes users and requests with WSMS 6. Specifically, security service 40H may receive authentication requests from client applications and/or other services 40 to access data in data layer 46 and/or perform processing in application layer 38. An authentication request may include credentials, such as a username and password. Security service 40H may query worker data repository 48C to determine whether the username and password combination is valid. Worker data repository 48C may include security data in the form of authorization credentials, policies, and any other information for controlling access to WSMS 6. Worker data repository 48C may include authorization credentials, such as combinations of valid usernames and passwords for authorized users of WSMS 6. Other credentials may include device identifiers or device profiles that are allowed to access WSMS 6.

Security service 40H may provide audit and logging functionality for operations performed at WSMS 6. For instance, security service 40H may log operations performed by services 40 and/or data accessed by services 40 in data layer 46. Security service 40H may store audit information such as logged operations, accessed data, and rule processing results in audit data repository 48F. In some examples, security service 40H may generate events in response to one or more rules being satisfied. Security service 40H may store data indicating the events in audit data repository 48F.

Although generally described herein as images, videos, gestures, landmarks, or any other stored information described herein as being stored in data repositories 48, in some examples, data repositories 48 may additionally or alternatively include data representing such images, videos, gestures, landmarks, or any other stored information described herein. As one example, encoded lists, vectors, or the like representing a previously stored indicator image and/or AVR display may be stored in addition to, or as an alternative, the previously stored indicator image or AVR display itself. In some examples, such data representing images, videos, gestures, landmarks, or any other stored information described herein may be simpler to store, evaluate, organize, categorize, or the like in comparison to storage of the actual images, videos, gestures, landmarks, or other information.

In general, while certain techniques or functions are described herein as being performed by certain components or modules, it should be understood that the techniques of this disclosure are not limited in this way. That is, certain techniques described herein may be performed by one or more of the components or modules of the described systems. Determinations regarding which components are responsible for performing techniques may be based, for example, on processing costs, financial costs, power consumption, or the like.

In general, while certain techniques or functions are described herein as being performed by certain components, e.g., WSMS 6, safety glasses 14, or communication hubs 13, it should be understood that the techniques of this disclosure are not limited in this way. That is, certain techniques described herein may be performed by one or more of the components of the described systems. For example, in some instances, safety glasses 14 may have a relatively limited sensor set and/or processing power. In such instances, one of communication hubs 13 and/or WSMS 6 may be responsible for most or all of the processing of data, identifying the field of view and relevant information, or the like. In other examples, safety glasses 14 and/or communication hubs 13 may have additional sensors, additional processing power, and/or additional memory, allowing for safety glasses 14 and/or communication hubs 13 to perform additional techniques. In other examples, other components of system 2 may be configured to perform any of the techniques described herein. For example, other articles of PPE, safety stations 15, beacons 17, sensing stations 21, communication hubs, a mobile device, another computing device, or the like may additionally or alternatively perform one or more of the techniques of the disclosure. Determinations regarding which components are responsible for performing techniques may be based, for example, on processing costs, financial costs, power consumption, or the like.

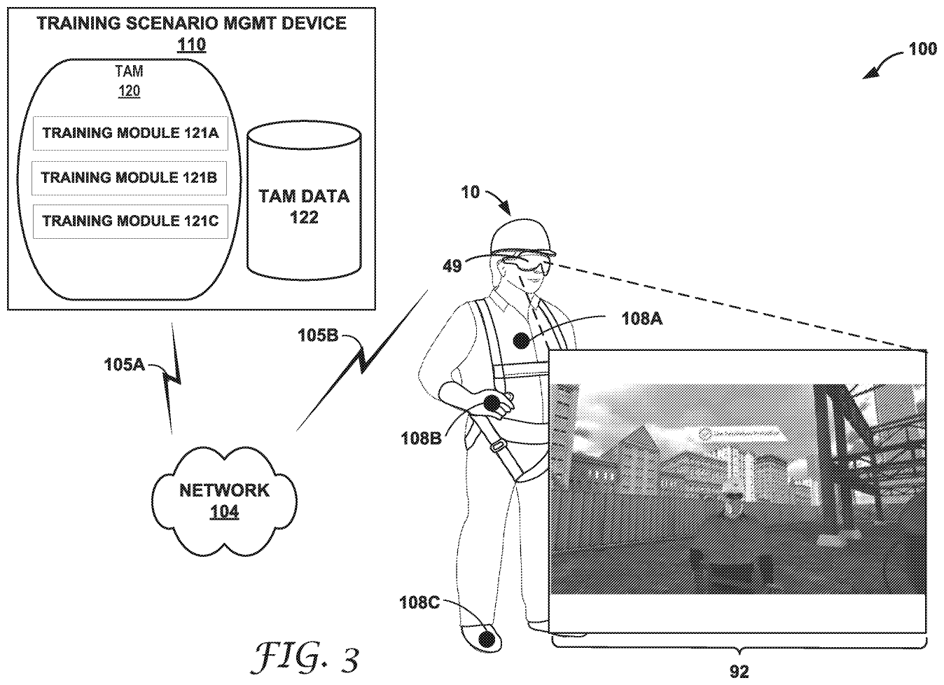

FIG. 3 is a block diagram illustrating an example virtual reality system, in accordance with one or more aspects of the present disclosure. System 100 of FIG. 3 includes worker 10, AVR device 49, one or more sensors 108A-108C (“sensors 108”), network 104, and training scenario management device 110. As used throughout this disclosure, a worker may refer to any person within a work environment, such as a tradesperson, laborer, supervisor, or inspector, among others.

AVR device 49 is configured to be worn by a user. For example, AVR 49 may include a strap or other attachment device configured to secure AVR device to the user's head. In some instances, AVR device 49 may include one or more input devices, one or more output devices, or a combination thereof. Examples of input include audio, visual, tactile. Examples of output include audio, visual, tactile. AVR 49 may include one or more display devices configured to cover a user's eyes, one or more speakers. For example, AVR device 49 may output graphical user interfaces, such as a virtual reality interface, augmented reality interface, or mixed reality interface.

Training scenario management device 110 is a computing device, such as a smartphone, laptop, desktop, or any other type of computing device. In some examples, training scenario management device 110 is configured to send and receive information (also referred to as data) via a network, such as network 104.

Network 104 represents any public or private communication network, for instance, cellular, Wi-Fi®, LAN, mesh network, and/or other types of networks for transmitting information between computing systems, servers, and computing devices. Network 104 may provide computing devices, such as AVR device 49 and training scenario management device 110 with access to the Internet, and may allow the computing devices to communicate with each other. AVR device 49 and training scenario management device 110 may each be operatively coupled to network 104 using any type of network connections, such as wired or wireless connections.

In some examples, one or more computing devices of system 100 may exchange information with another computing device without the information traversing network 104. For example, sensors 108 may communicate with training scenario management device 110 and/or AVR device 49 via a direct connection (e.g., without requiring a network switch, hub, or other intermediary network device), for example, via Bluetooth®, Wi-Fi Direct®, near-field communication, etc.

Sensors 108 are configured to detect motion of worker 10. In some examples, one or more of sensors 108 include motion sensors (e.g., accelerometers, gyroscopes, etc.). As another example, one or more of sensors 108 include an optical image sensor (e.g., a camera). For example, a camera may capture a plurality of images and detect motion by detecting differences between the plurality of images. Sensors 108 may be standalone devices, or may be part of another article, such as an article of apparel (e.g., a jacket, shirt, trousers or pants, gloves, hat, shoes, etc.) that may be worn by a human.

Training scenario management computing device 110 includes PPE training application module (TAM) 120 and one or more data repositories 122, such as PPE training application module data repository 122. Although not shown in FIG. 3, AVR device 49 may include similar components or modules as training scenario management device 110. Module 120 may perform operations described using hardware, hardware and firmware, hardware and software, or a mixture of hardware, software, and firmware residing in and/or executing at computing device 110. Computing device 110 may execute module 120 with one or multiple processors or multiple devices. Computing device 110 may execute module 120 as virtual machines executing on underlying hardware. Module 120 may execute as one or more services of an operating system or computing platform. Module 120 may execute as one or more executable programs at an application layer of a computing platform.

In accordance with some examples of this disclosure, PPE TAM 120 presents one or more virtual training environments by executing one or more respective training modules 121A-121C (collectively, “training modules 121”). For example, training scenario management device 110 may execute TAM 120 and TAM 120 may output data indicative of a menu graphical user interface (GUI). For example, the data indicative of the menu GUI may include data that, when received by a display device (e.g., AVR device 49), causes the display device to output the menu GUI. The menu GUI may include one or more graphical elements (also referred to as graphical objects) indicative of one or more respective training modules. For example, TAM 120 may include one or more training modules 121 for educating employees about proper safety precautions within a work environment, such as a construction site or a manufacturing facility. In some examples, a graphical object may include text, an image, an icon, a shape, a character, among others. For example, the menu GUI may include a plurality of training module graphical objects that each represent a respective training module. In some instances, each training module graphical object includes an image and/or text description of the respective training module. AVR device 49 receives the data indicative of the menu GUI and outputs the menu GUI via the display device of AVR 49.

TAM 120 may receive data indicative of a user input selecting a particular training module graphical object of the menu GUI. For example, TAM may receive sensor data indicative of motion of worker 10. For instance, worker 10 may wear one or more gloves (e.g., one on each hand) that each include a motion sensor 108 (also referred to as movement sensors) or may hold one or more controllers (e.g., one controller in each hand) that each include a motion sensor 108. Sensors 108 may detect movement of the worker and output sensor data indicative of the detected motion. TAM 120 may receive the sensor data and determine, based on the sensor data, whether worker 10 selected a training module graphical object displayed by AVR device 49. For instance, the menu GUI may include a graphical object representative of the user's hand and may move the graphical object representative of the user's hand in response to the sensor data generated by the glove or controller. TAM 120 may determine that the user input is a gesture selecting a particular training module graphical object in response to determining that the location of the graphical object representative of the user's hand within the virtual environment corresponds to the location of the particular training model graphical object within the virtual environment.

Responsive to determining the worker 10 selected a particular training model graphical object from the menu GUI, TAM 120 may execute the corresponding training module 121. In some examples, training module 121A includes a module to train the user to identify appropriate first personal protective equipment associated with a first hazard. Training module 121B may include a module to train the user to identify whether second personal protective equipment associated with a second hazard is being utilized properly. Training module 121C may include training the user to properly utilize third personal protective equipment to perform a particular task in a work environment associated with a third hazard.

TAM 120 may execute a particular training module (e.g., training module 121A) and output data indicative of a GUI corresponding to the particular training module. For example, the data indicative of the GUI may include data that, when received by a display device (e.g., AVR device 49), causes the display device to output a corresponding training module GUI 92.

In one example, training module 121A, may include a set of instructions that causes display device 49 to output a training module GUI 92 depicting a graphical representation of one or more construction workers performing one or more construction tasks, as well as a graphical display of an inventory of articles of personal protective equipment (PPE) that may or may not correspond to safety hazards presented by the construction tasks being performed by the one or more construction workers. In some examples, TAM 120 receives data indicative of a user input selecting a particular article of PPE from the inventory of PPE. For example, TAM 120 may receive sensor data from one or more sensors 108. TAM 120 may determine whether worker 10 selected an article of PPE that is appropriate for the graphically represented construction task by comparing the sensor data and a predetermined set of data queried from TAM Data 122 indicating correct PPE/construction task pairings. Responsive to TAM 120 determining that the PPE selection of worker 10 was correct, TAM 120 may output a set of instructions causing display device 49 to indicate to worker 10 that the selection was correct. For instance, AVR device may output audio data or visual data of the phrase “CORRECT.” As another example, TAM 120 may determine that the PPE selection of worker 10 was not correct (e.g., that the worker-selected PPE was not appropriate for the construction task being performed), TAM 120 may cause display device 49 to output an alert or alarm or other signal indicating to worker 10 that the selection was incorrect. TAM 120 may repeat this display/receive/determine/output procedure throughout training module 121A, for example, by causing display device of AVR 49 to display a graphical representation of a construction worker performing various construction task associated with a set of safety hazards in a virtual environment.

According to another example, training module 121B may include a set of instructions that causes display device 49 to output a training module GUI 92 depicting a graphical representation of one or more safety installations, for example, beam anchors, lifelines, and guardrails, or a visualization of location where a safety installation should be installed. GUI 92 may include selectable graphical objects, such as a plurality of graphical objects that indicate whether the virtual safety equipment is installed correctly. For instance, the graphical objects may include the text, such as the words “YES” and “NO”, respectively. According to some examples, TAM 120 receives data indicative of a user input selecting one of the graphical objects. For example, TAM 120 may receive sensor data as worker 10 moves his or her hands to select one of the graphical object representing “YES” or “NO”. TAM 120 may determine, by comparing the sensor data to predetermined set of data queried from TAM data 122 indicating correct safety installations, whether worker 10 selected the correct graphical object (e.g., the graphical object that includes the word “YES”). Responsive to determining that worker 10 selected the correct graphical object (e.g., worker 10 selected a graphical object indicating the virtual PPE was installed correctly when the virtual PPE was installed correctly) TAM 120 may output a set of instructions causing AVR device 49 to output a GUI indicating to worker 10 that the selection was correct. For instance, AVR device 49 may output audio or video of the phrase “CORRECT.” However, if TAM 120 determines that the worker selected the wrong graphical object (e.g., worker 10 selected a graphical object indicating the virtual PPE was installed correctly when the virtual PPE was installed incorrectly) TAM 120 may cause AVR device 49 to output an alert or alarm or other signal indicating to worker 10 that the selection was incorrect. Additionally, for instances of safety installations that were not properly installed or where worker 10 selected the wrong graphical object, TAM 120 may cause AVR device 49 to display on GUI 92 an animation of the safety installation correcting itself, and/or an audio or visual explanation of which aspect of the safety installation was incorrectly installed, and the safety hazard that may present. TAM 120 may repeat this display/receive/determine/output procedure a predetermined number of times throughout training module 121B, each time causing display device to display a graphical representation of a safety installation, or alternatively, a graphical representation of a location where a safety installation should have been installed, but had not been.

In some examples, training module 121C may include a set of instructions that causes AVR device 49 to output a training module GUI instructing the user to select one or more articles of PPE for a particular task or work environment, a GUI in which worker 10 may learn how to use the one or more articles of PPE, or both. For example, AVR device 49 may display a graphical representation of a set of one or more articles of PPE and a notification instructing the worker to select the correct PPE from the for a particular work environment. TAM 120 may receive a user input selecting at least one of the articles of PPE and may output data indicating whether the selection was appropriate (e.g., according to regulations) and/or how to use the selected PPE. As another example, TAM 120 may cause AVR device 49 to display a graphical representation 92 of a construction site having a construction task to be performed. TAM 120 receives user input, for example, from motion sensors 108, indicative of worker 10 simulating the performance of the construction task. TAM 120 may cause AVR device 49 to output audio or visual instructions to assist worker 10 to perform the construction task to completion.

In this way (e.g. by implementing safety training simulations in a highly realistic yet non-hazardous environment), techniques of this disclosure enable a computing device to significantly increase both the present attentiveness and future retention of corresponding safety training principles and methods, and as a result, directly increase workplace safety and reduce both the number and frequency of workplace safety incidents.

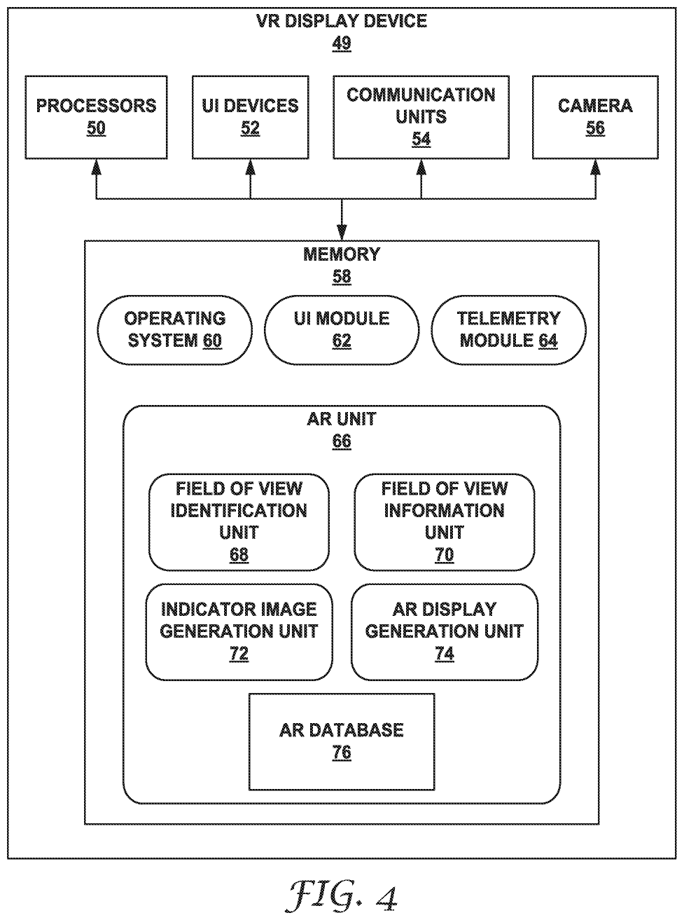

FIG. 4 is a block diagram illustrating an example virtual reality device 49 configured to present an AVR display of a field of view of a work environment, in accordance with various techniques of this disclosure. The architecture of AVR device 49 illustrated in FIG. 4 is shown for exemplary purposes only and AVR device 49 should not be limited to this architecture. In other examples, AVR device 49 may be configured in a variety of ways. In some examples, AVR device 49 may include safety glasses, such as safety glasses 14 of FIG. 1, a welding mask, a face shield, or another article of PPE.

As shown in the example of FIG. 4, AVR device 49 includes one or more processors 50, one or more user interface (UI) devices 52, one or more communication units 54, a camera 56, and one or more memory units 58. Memory 58 of AVR device 49 includes operating system 60, UI module 62, telemetry module 64, and AVR unit 66, which are executable by processors 50. Each of the components, units, or modules of AVR device 49 are coupled (physically, communicatively, and/or operatively) using communication channels for inter-component communications. In some examples, the communication channels may include a system bus, a network connection, an inter-process communication data structure, or any other method for communicating data.

Processors 50, in one example, may include one or more processors that are configured to implement functionality and/or process instructions for execution within AVR device 49. For example, processors 50 may be capable of processing instructions stored by memory 58. Processors 50 may include, for example, microprocessors, DSPs, ASICs, FPGAs, or equivalent discrete or integrated logic circuitry, or a combination of any of the foregoing devices or circuitry.

Memory 58 may be configured to store information within AVR device 49 during operation. Memory 58 may include a computer-readable storage medium or computer-readable storage device. In some examples, memory 58 includes one or more of a short-term memory or a long-term memory. Memory 58 may include, for example, RAM, DRAM, SRAM, magnetic discs, optical discs, flash memories, or forms of EPROM, or EEPROM. In some examples, memory 58 is used to store program instructions for execution by processors 50. Memory 58 may be used by software or applications running on AVR device 49 (e.g., AVR unit 66) to temporarily store information during program execution.

AVR device 49 may utilize communication units 54 to communicate with other systems, e.g., WSMS 6 of FIG. 1, via one or more networks or via wireless signals. Communication units 54 may be network interfaces, such as Ethernet interfaces, optical transceivers, radio frequency (RF) transceivers, or any other type of devices that can send and receive information. Other examples of interfaces may include Wi-Fi, NFC, or Bluetooth® radios.

UI devices 52 may be configured to operate as both input devices and output devices. For example, UI devices 52 may be configured to receive tactile, audio, or visual input from a user of AVR device 49. In addition to receiving input from a user, UI devices 52 may be configured to provide output to a user using tactile, audio, or video stimuli. For instance, UI devices 52 may include a display configured to present the AVR display as described herein. The display may be arranged on AVR device 49 such that the user of AVR device 49 looks through the display to see the field of view. Thus, the display may be at least partially transparent. The display may also align with the user's eyes, such as, for example, as (or a part of) lenses of a pair of safety glasses (e.g., safety glasses 14 of FIG. 1). Other examples of UI devices 52 include any other type of device for detecting a command from a user, a sound card, a video graphics adapter card, or any other type of device for converting a signal into an appropriate form understandable to humans or machines.

Camera 56 may be configured to capture images, a video feed, or both of the field of view as seen by the user through AVR device 49. In some examples, camera 56 may be configured to capture the images and/or video feed continuously such that AVR device 49 can generate an AVR display in real time or near real time. In some cases, camera 56 or an additional camera or sensor may be configured to track or identify a direction of a user's eyes. For example, camera 56 or the additional camera may be configured capture an image, video, or information representative of where the user may be looking through AVR device 49. Although described herein as a camera 56, in other examples, camera 56 may include any sensor capable of detecting the field of view of AVR device 49.

Operating system 60 controls the operation of components of AVR device 49. For example, operating system 60, in one example, facilitates the communication of UI module 62, telemetry module 64, and AVR unit 66 with processors 50, UI devices 52, communication units 54, camera 56, and memory 58. UI module 62, telemetry module 64, and AVR unit 66 may each include program instructions and/or data stored in memory 58 that are executable by processors 50. For example, AVR unit 66 may include instructions that cause AVR device 49 to perform one or more of the techniques described herein.

UI module 62 may be software and/or hardware configured to interact with one or more UI devices 52. For example, UI module 62 may generate audio or tactile output, such as speech or haptic output, to be transmit to a user through one or more UI devices 52. In some examples, UI module 62 may process an input after receiving it from one of UI devices 52, or UI module 62 may process an output prior to sending it to one of UI devices 52.

Telemetry module 62 may be software and/or hardware configured to interact with one or more communication units 54. Telemetry module 62 may generate and/or process data packets sent or received using communication units 54. In some examples, telemetry module 64 may process one or more data packets after receiving it from one of communication units 54. In other examples, telemetry module 64 may generate one or more data packets or process one or more data packets prior sending it via communication units 54.

In the example illustrated in FIG. 4, AVR unit 66 includes field of view identification unit 68, field of view information unit 70, indicator image generation unit 72, AVR display generation unit 74, and AVR database 76. Field of view identification unit 68 may be the same or substantially the same as field of view analyzer 40A of FIG. 2; field of view information unit 70 may be the same or substantially the same as information processor 40B of FIG. 2; indicator image generation unit 72 may be the same of substantially the same as indicator image generator 40C of FIG. 2; AVR display generation unit 74 may be the same or substantially the same as AVR display generator 40D of FIG. 2; and AVR database 76 may include contents similar to any one or more data repositories 48 of FIG. 2. Thus, the descriptions of functionalities of field of view identification unit 68, field of view information unit 70, indicator image generation unit 72, AVR display generation unit 74, and AVR database 76 will not be repeated herein. In some examples, field of view identification unit 68 may, as described above, apply localization to determine position an orientation using one or more accelerometers, image data from camera 56, GPS sensors, or combinations thereof, and may communicate the information to WSMS 6.

AVR device 49 may include additional components that, for clarity, are not shown in FIG. 4. For example, AVR device 49 may include a battery to provide power to the components of AVR device 49. Similarly, the components of AVR device 49 shown in FIG. 4 may not be necessary in every example of AVR device 49. For example, in some cases, WSMS 6, communication hubs 13, a mobile device, another computing device, or the like may perform some or all of the techniques attributed to AVR unit 66, and thus, in some such examples, AVR device 49 may not include AVR unit 66.

In some examples, AVR device 49 may include functionality of computing device 110 of FIG. 3. For example, AVR device 49 may include a PPE training application similar to TAM 120 of FIG. 3. AVR device 49 may execute various training modules 121 and output graphical user interfaces representing virtual work environments, where the virtual work environments correspond to the respective training modules 121. AVR device 49 may receive sensor data generated by one or more internal or external sensors (e.g., sensors 108 of FIG. 3) as a worker 10 interacts with a virtual environment. For example, AVR device 49 may execute TAM 120 to train one or more workers 10 to identify appropriate PPE for given work environments and/or hazards, how to utilize such PPE, or both.

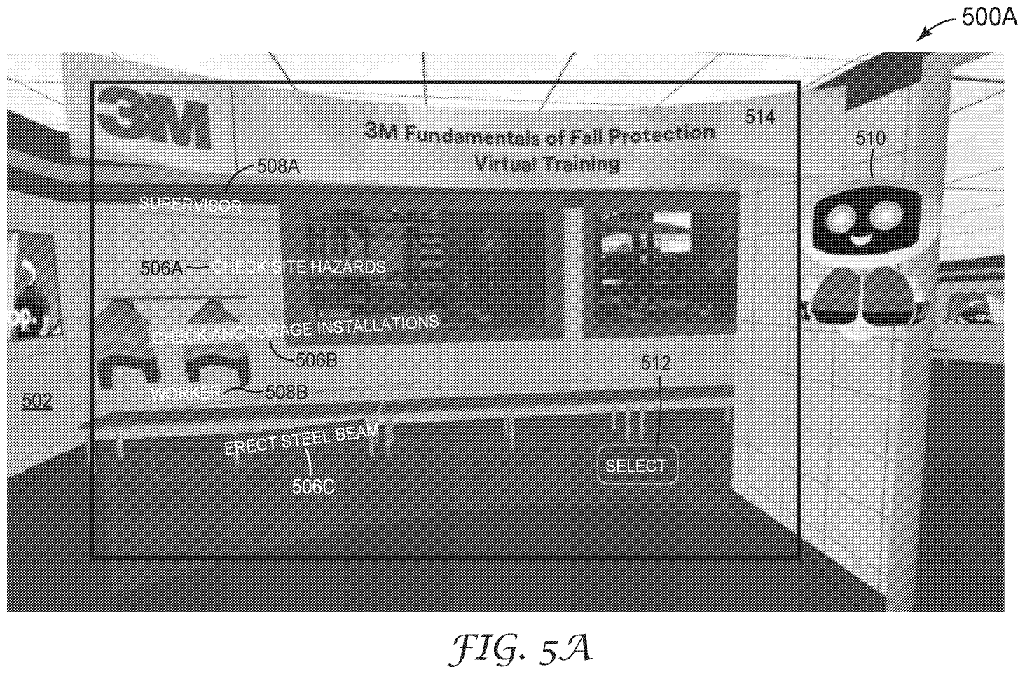

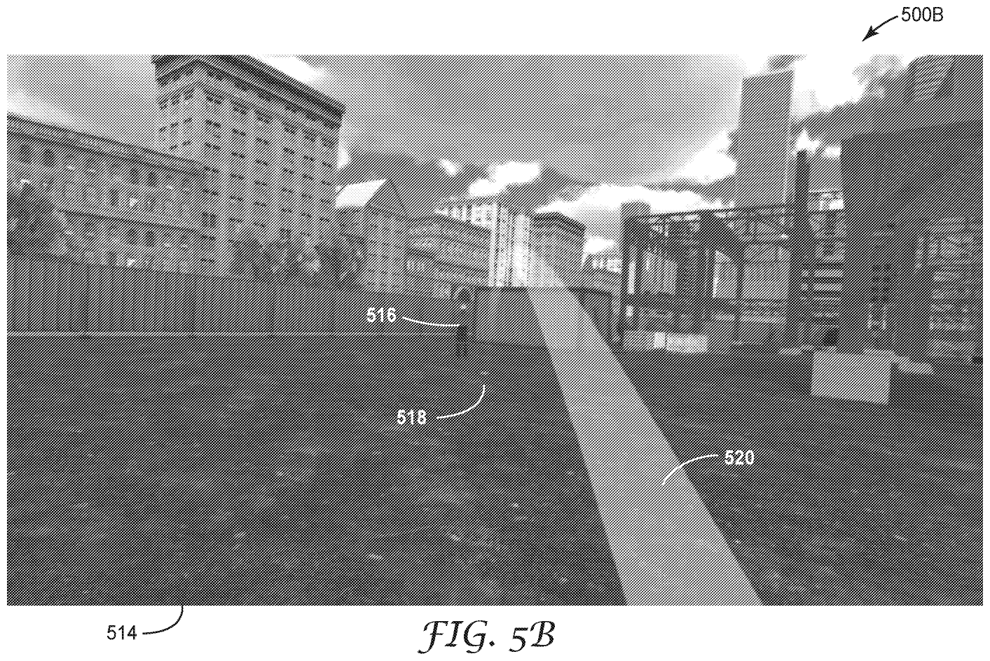

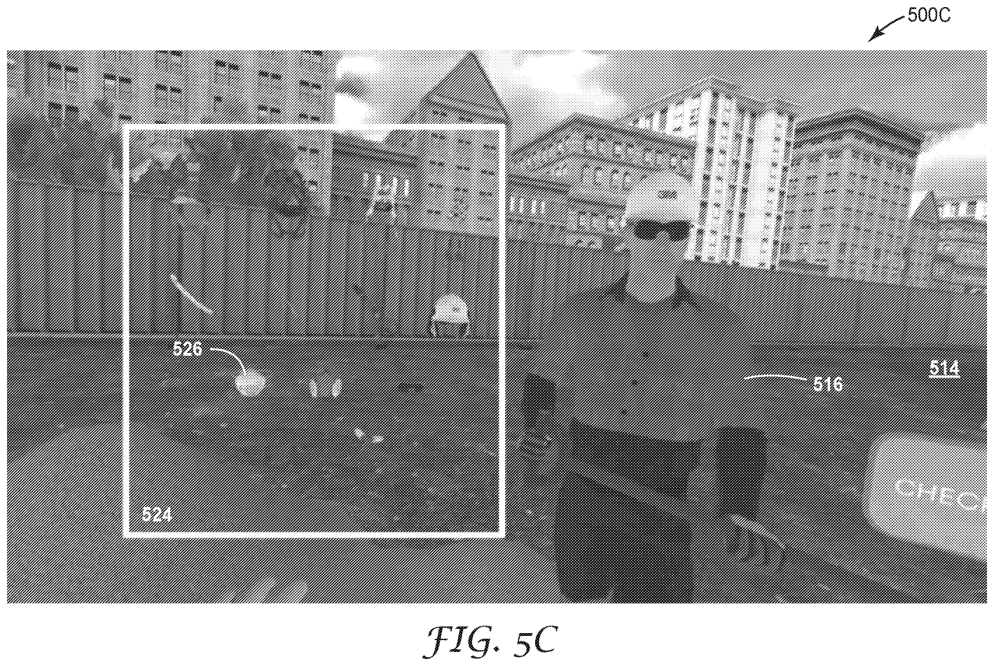

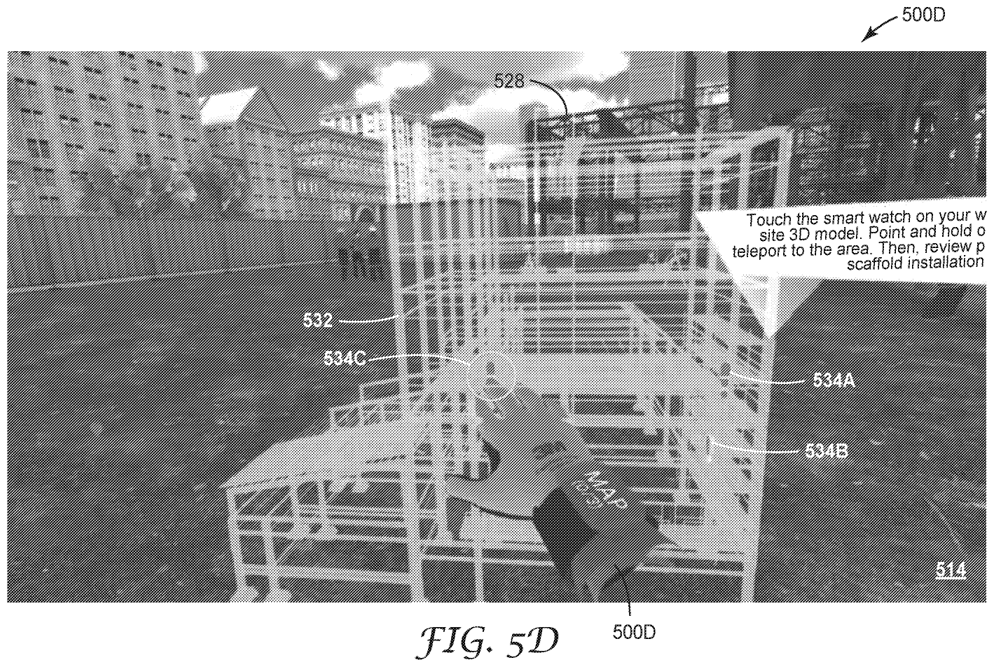

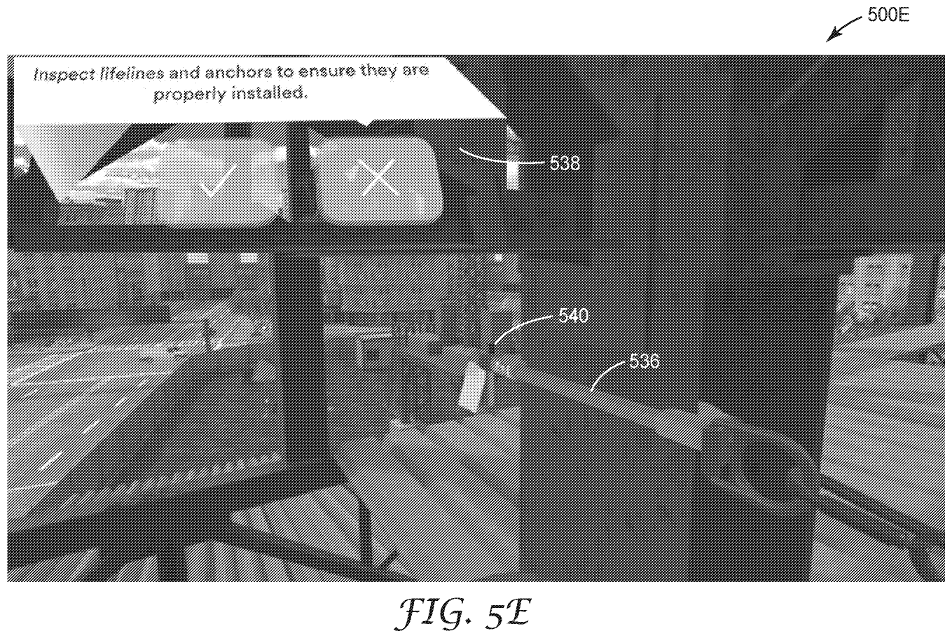

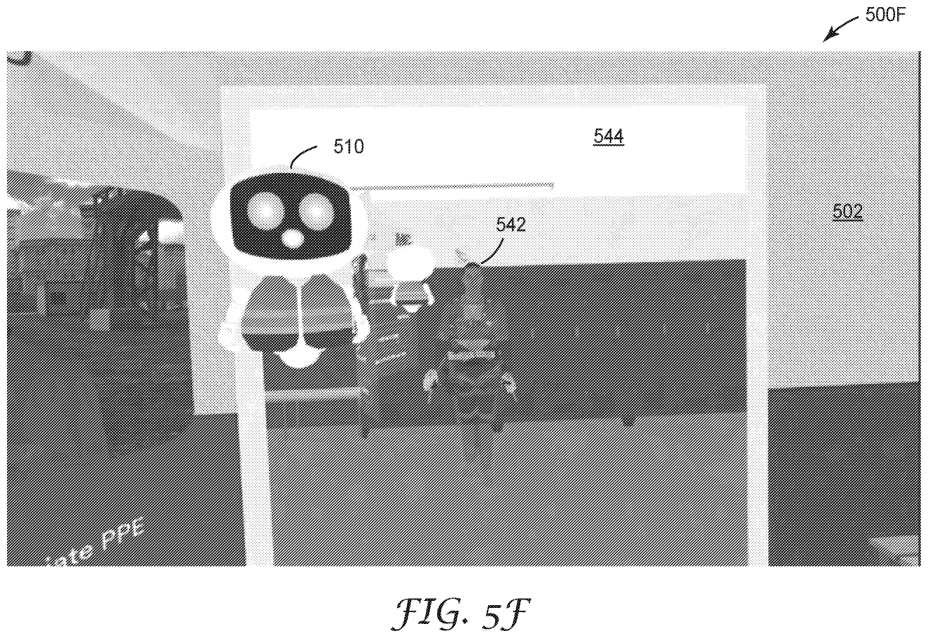

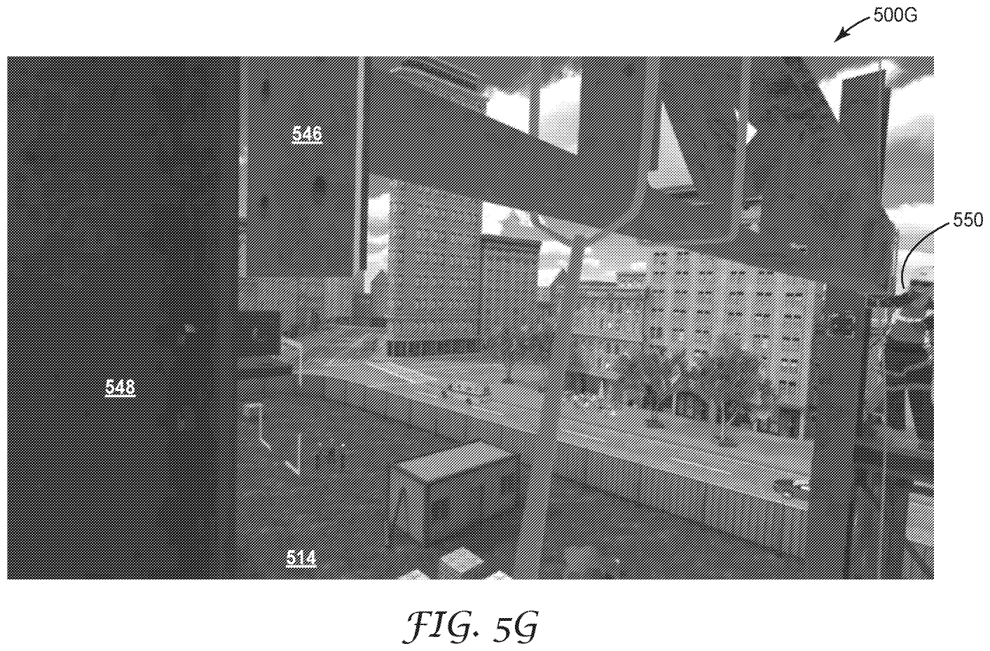

FIGS. 5A-5G depict example VR graphical user interfaces, in accordance with some techniques of this disclosure. FIGS. 5A-5G illustrate, respectively, example graphical user interfaces 500A-500G (collectively, graphical user interfaces 500). However, many other examples of graphical user interfaces may be used in other instances. Each of graphical user interfaces 500 may correspond to a graphical user interface output by AVR device 49 of FIG. 3 or FIG. 4.

As illustrated in the example of FIG. 5A, GUI 500A illustrates an initial graphical user interface displayed by AVR 49 in response to training scenario management device 110 executing PPE TAM 120. GUI 500A may include a menu 504 displayed in front of the user. Menu 504 may include one or more training module graphical objects 506A-506C (collectively, training module graphical objects 506) corresponding to safety training modules 121A-121C of FIG. 3 from which the user may select.

Training module graphical objects 506 may be grouped into a number of different categories 508A-508B (collectively, categories 508). In some examples, categories 508 may be based in part on the user's intended role within the work environment. For example, as illustrated in FIG. 5A, category 5A may be associated with training modules directed toward jobs that are performed by a supervisory role, whereas category 508B may be associated with training modules directed toward tasks performed directly by a construction or manufacturing worker.

GUI 500A may depict a primary location from which a user may select a particular training module to perform. For example, the primary location may take the form of a virtual locker room 502 with a virtual robot 510 that may provide information to a user.

As illustrated in the example of FIG. 5A, training module graphical object 506A includes a description or other indication of the training module corresponding to graphical object 506A (e.g., the text “CHECK SITE HAZARDS,”). In some examples, selecting training module graphical object 506 may cause menu 504 to display more information regarding that module. For example, selecting the “CHECK SITE HAZARDS” graphical object 506A may cause AVR 49 to update GUI 500A to display an associated graphical object indicating additional information about training module corresponding to graphical object 506A, such as text that says, “Ensure workers have all appropriate PPE.” Alternatively or additionally, selecting a particular training module may result in an audio device playing an audio file describing more information about that module. For example, selecting graphical object 506A may cause AVR device 49 to animate virtual robot 510 and output audio that says, “This task requires you to walk around the job site to ensure every worker has appropriate PPE to perform their tasks.”

As illustrated in FIG. 5A, training module graphical object 506B appearing on menu 504 includes a description or other indication of the training module corresponding to graphical object 506B, such as the text “CHECK ANCHORAGE INSTALLATIONS.” In some examples, selecting graphical object 506B may cause AVR device 49 to update GUI 500A to display additional graphical objects associated with the training module corresponding to graphical object 506B, such as text that says, “Review proper anchor points or scaffold installation.” Alternatively or additionally, selecting a particular training module may result in the playing of an audio file describing more information about that module. For example, selecting graphical object 506B may cause AVR device 49 to animate virtual robot 510 and output (e.g., via an audio device) audio that says, “This task requires you to walk around the job site to ensure all anchor points are installed correctly.”

In the example of FIG. 5A, training module graphical object 506C includes a description or other indication of the training module corresponding to graphical object 506C, such as the text “ERECT STEEL BEAM.” In some examples, selecting graphical object 506C may cause AVR device 49 to update GUI 500A to display additional graphical objects associated with the training module corresponding to graphical object 506B. The additional graphical object may include more information regarding the selected module. For example, selecting the “ERECT STEEL BEAM” graphical object 506C may cause AVR 49 to update GUI 500A to display one or more additional graphical objects associated with the training module corresponding to graphical object 506C, such as text that says, “You will drive an aerial lift to a landing position. With the help of another worker, guide the steel beam and bolt into place.” Alternatively or additionally, selecting graphical object 506C may cause AVR device 49 to output audio data describing more information about that module, such as outputting audio that says, “This training module will help expand your understanding of fall protection and the importance of wearing personal protective equipment.”

The user may confirm his selection of a training module, for example, by choosing graphical object 512 (e.g., a “SELECT” button) from menu 504. Responsive to receiving motion data indicating the user has selected graphical object 512 (e.g., has confirmed a selection of a particular graphical object of graphical objects 506 (e.g., corresponding to a particular training module 121) from menu 504, the worker may be virtually transported from the primary location (e.g., a locker room 502), to a virtual work site corresponding to the training module. For example, AVR 49 may output a graphical user interface (e.g., GUI 500B) associated with the training module that corresponds to the selected graphical object 506.

FIG. 5B depicts an example GUI 500B in accordance with some examples of this disclosure. Responsive to determining that a user has confirmed a selection of a training module from a menu, AVR device 49 may display a virtual work site 514. For example, selecting the “CHECK SITE HAZARDS” training module graphical object 506A associated with training module 121A may cause AVR 49 to display a GUI 500B associated with training module 121A. In the example of FIG. 5B, GUI 500B includes a graphical representation of a virtual construction site 514, which may include one or more graphical objects 516 representing respective virtual construction workers performing various tasks around construction site 514. In the example of FIG. 5B, the user may complete the training module by navigating between the construction workers to evaluate whether each worker is wearing correct and sufficient personal protective equipment (PPE) (e.g., according to one or more rules) to protect the virtual worker from one or more hazards (e.g., hazards associated with a task that the virtual worker performs). In some examples, the user may navigate between virtual workers (e.g., to different graphical objects 516 representing virtual workers) at the construction site 514 using a set of handheld controllers as input devices. For example, computing device 110 may receive sensor data from sensors 108 indicating a user input from worker 10 to navigate through the virtual work environment. Responsive to receiving the user input to navigate through the virtual work environment 514 (also referred to as a virtual worksite), AVR device 49 may update GUI 500A to display a marker 518 on the ground of the virtual worksite 514. Sensors 108 may output sensor data indicative of user movement (e.g., worker 10 may utilize computerized gloves or handheld controllers that include motion sensors) and computing device 110 may determine that the sensor data indicates a user input to move marker 518 to a particular location within the virtual worksite 514. Responsive to receiving the user input to move marker 518 AVR device 49 may update GUI 500B to display the environment around the location of marker 518, causing it to appear as though the user has transported to that location of the virtual work environment 514. In some examples, the intended path of the user may be indicated by an arc of light 520 connecting the user's current location to the user's intended location.

FIG. 5C depicts an example GUI 500C in accordance with some examples of this disclosure. GUI 500C may include a graphical object 516 representing a virtual construction worker. AVR device 49 may output data prompting worker 10 to identify whether the virtual worker corresponding to graphical object 516 is wearing or using the appropriate PPE and/or identify the appropriate PPE for the job the virtual worker is performing. In one example, the construction task of worker 516 may include shoveling sand or other fine-grained particulate substance. In a real world work environment, this task would typically present a respiratory hazard to a worker, such that the worker should wear an article of respiratory protection (e.g., a respirator or dust mask). GUI 500C may include graphical object 524 representing a “digital crib” PPE inventory. Graphical object 524 may include a plurality of graphical objects 526 representing various articles of virtual PPE. In some examples, the user may activate the PPE inventory display by selecting a virtual smartwatch on the wrist of the user's virtual avatar by touching his own wrist with his opposite hand for a short period of time, such as three seconds. For example, computing device 110 may determine, based on sensor data generated by sensors 108, that worker 10 has selected the virtual smartwatch and may cause AVR device 49 to output graphical object 524 in response to determining that worker 10 selected the virtual smartwatch.

Responsive to outputting graphical object 524, computing device 110 may detect a user input (e.g., based on the motion data from sensors 108) to select one or more graphical objects 526 indicative respective articles of PPE. Computing device 110 may detect a user input selecting a graphical object 522 to verify whether the worker selected the correct virtual PPE. Responsive to receiving the user input, PPE TAM 120 of computing device 110 may determine whether worker 10 selected the correct virtual PPE for the virtual worker represented by graphical object 516. TAM 120 may output data indicating whether worker 10 correctly identified the correct virtual PPE, for example, by causing AVR device 49 to output graphical or audio data indicating whether worker 10 selected the appropriate PPE.

In another example training module 121A, TAM 120 may output instructions prompting worker 10 to identify whether the virtual worker corresponding to graphical object 516 is wearing or using the appropriate PPE and/or identify the appropriate PPE for the job the virtual worker is performing. In one example, the construction task of worker 516 may include a machine emitting high levels of noise. In a real-world work environment, this task would typically present a hazard to the hearing of the worker, such that the worker would require an article of hearing protection (e.g., ear plugs or earmuffs). GUI 500C may include graphical object 524 representing a “digital crib” PPE inventory. Graphical object 524 may include a plurality of graphical objects 526 representing various articles of virtual PPE. In some examples, the user may activate the PPE inventory display by selecting a virtual smartwatch on the wrist of the user's virtual avatar by touching his own wrist with his opposite hand for a short period of time, such as three seconds. For example, computing device 110 may determine, based on sensor data generated by sensors 108, that worker 10 has selected the virtual smartwatch and may cause AVR device 49 to output graphical object 524 in response to determining that worker 10 selected the virtual smartwatch.

Responsive to outputting graphical object 524, computing device 110 may detect a user input (e.g., based on the motion data from sensors 108) to select one or more graphical objects 526 indicative respective articles of PPE. Computing device 110 may detect a user input selecting a graphical object 522 to verify whether the worker selected the correct virtual PPE. Responsive to receiving the user input, PPE TAM 120 of computing device 110 may determine whether worker 10 selected the correct virtual PPE for the virtual worker represented by graphical object 516. TAM 120 may output data indicating whether worker 10 correctly identified the virtual PPE, for example, by causing AVR device 49 to output graphical or audio data indicating whether worker 10 selected the appropriate PPE.

TAM 120 may terminate training module 121A by either receiving user input indicative of the user's intent to terminate the training module (e.g., by selecting an “end module” graphical object), or alternatively, by determining that the user has completed the training module by completing an interaction with every worker 516. Responsive to terminating training module 121A, TAM 120 may cause AVR device 49 to display the GUI's primary location (e.g., virtual locker room 502 in FIG. 5A). TAM 120 may await user input indicative of a selection of a new training module 121 from the menu (504 in FIG. 5A).

FIG. 5D depicts an example GUI 500D in accordance with some examples of this disclosure. Responsive to determining that a user has confirmed a selection of a training module from menu 504, AVR device 49 may display a virtual work site 514. For example, selecting the “CHECK ANCHORAGE INSTALLATIONS” training module graphical object 506B associated with training module 121B may cause AVR 49 to display a GUI 500D associated with training module 121B. In the example of FIG. 5D, GUI 500D includes a graphical representation of a virtual construction site 514, which may include one or more graphical objects representing respective virtual safety equipment installations (e.g., anchor points, lifelines, or guardrails). In the example of FIG. 5D, the user may complete the training module by navigating between the safety installations to evaluate whether each safety installation has been installed correctly (e.g., according to one or more rules). In some examples, AVR device 49 may display a three-dimensional model 532 of construction site 514 that provides functionality for the user to navigate between safety installations (e.g., to different graphical objects representing safety installations). For example, TAM 120 may receive user input indicating a selection of a particular location on 3D model 532 having safety installation 534A. Responsive to determining the user's selection of a location on 3D model 532, TAM 120 may cause AVR device 49 to display the immediate environment within construction site 514 corresponding to the selected location on 3D model 532.

FIG. 5E depicts an example GUI 500E in accordance with some examples of this disclosure. GUI 500E may include a graphical object 536 representing a virtual safety installation. TAM 120 may output instructions prompting worker 10 to identify whether the safety installation corresponding to graphical object 536 appears to be installed correctly. In one example, graphical object 536 may depict a beam anchor with corresponding anchor pin 540 that may or may not be correctly inserted. Additionally, AVR device 49 may display a graphical menu 538 featuring two binary options allowing the user to indicate whether he believes safety installation 536 is correctly installed. TAM 120 receives user input (e.g., based on the motion data from sensors 108) indicating the user's selection. Responsive to receiving user input indicating the binary selection, TAM 120 may retrieve (e.g. from TAM Data 122 in FIG. 3) information indicating the “correct” selection from menu 538 and compare it to the user input indicating the user's selection, to determine whether the user's selection was correct. TAM 120 may output data indicating whether worker 10 correctly evaluated the safety installation, for example, by causing AVR device 49 to output graphical or audio data indicating whether the selection of worker 10 was correct.

In another example of training module 121B, AVR device 49 may display a location within a virtual construction site (e.g., an elevated walkway or scaffolding) and information prompting the user to determine whether guardrails have been properly installed at that location. Additionally, AVR device 49 may display a graphical menu 538 featuring two binary options allowing the user to indicate whether he believes guardrails have been correctly installed. TAM 120 receives user input (e.g., based on the motion data from sensors 108) indicating the user's selection. Responsive to receiving user input indicating a binary selection, TAM 120 may retrieve (e.g. from TAM Data 122 in FIG. 3) information indicating the “correct” selection from menu 538 and compare it to the user input indicating the user's selection to determine whether the user's selection was correct. TAM 120 may output data indicating whether worker 10 correctly determined the presence of necessary guardrails, by causing AVR device 49 to output graphical or audio data indicating whether worker 10 selected the appropriate option from menu 538.

TAM 120 may terminate training module 121B either by receiving user input indicative of the user's intent to terminate the training module (e.g., by selecting an “end module” graphical object), or alternatively, by determining that the user has completed the training module by evaluating every safety installation 536. Responsive to terminating training module 121B, TAM 120 may cause AVR device 49 to display the GUI's primary location (e.g., virtual locker room 502 in FIG. 5A). TAM 120 may await user input indicative of a selection of a new training module 121 from the menu (504 in FIG. 5A).

FIG. 5F depicts an example GUI 500F in accordance with some examples of this disclosure. Responsive to determining a user's selection of a training module graphical object from a menu (504 in FIG. 5A), GUI 500F may display graphical information educating worker 10 about personal protective equipment, before commencing a construction task simulation. For example, selecting the “ERECT STEEL BEAM” training module graphical object (506C in FIG. 5A) may cause AVR device 49 to display a set of information about personal protective equipment, for example, fall protection. In some examples, this information may be conveyed via the animation of virtual robot 510 or other third-person narration. In some examples, the education module and narration may be conducted by a second user simultaneously engaged with the system. The second user may be locally connected to the first user, or provide digital instructions remotely. For example, the second user may be a trainer (e.g., located in the same physical location as the user, or a separate physical location) who instructs the user within the virtual environment on how to use the personal protective equipment, verify the personal protective equipment is utilized correctly, or select appropriate personal protective equipment for a given work environment and/or task.

For example, GUI 500F may include textual information that says, “A: Anchorages are a secure point of attachment. Anchorage connectors vary by industry, job, type of installation and structure. They must be able to support the intended loads and provide a sufficient factor of safety for fall arrest,” while the robot 510 narrates. GUI 500F may additionally include textual information that says, “B: Body support harnesses distribute fall forces over the upper thighs, pelvis, chest and shoulders. They provide a connection point on the worker for the personal fall arrest system.”

GUI 500F may additionally include textual information that says, “C: Connectors such as shock-absorbing lanyards or self-retracting lifelines connect a worker's harness to the anchorage.” GUI 500F may then display a set of personal protective equipment related to fall protection, and prompt worker 10 to select one or more articles. Responsive to TAM 120 determining the user's selection via user input data, TAM 120 may cause AVR device 49 to display the selected articles on the body of the avatar of worker 10. In some examples, GUI 500F may include virtual mirror 544 within locker room 502 allowing worker 10 to evaluate the appearance of the PPE on the user's avatar 542.

FIG. 5G depicts an example GUI 500G in accordance with some examples of this disclosure. Responsive to determining that a user has confirmed a selection of a training module from menu 504 and displaying educational information, AVR device 49 may display a virtual work site 514. For example, selecting the “ERECT STEEL BEAM” training module graphical object 506C associated with training module 121C may cause AVR 49 to display a GUI 500G associated with training module 121C. In the example of FIG. 5G, GUI 500G includes a graphical representation of a virtual construction site 514, which may include the frame of a building under construction. In the example of FIG. 5G, the user may complete the training module by navigating a virtual aerial lift to a beam installation site, guiding a steel beam, and securing the steel beam in place. In some examples, AVR device 49 may display instructions guiding worker 10 to a beam installation site on a raised platform.

TAM 120 may execute instructions to prompt user 10 to utilize a virtual article of PPE. For example, AVR device 49 may display instructions prompting worker 10 to secure a fall protection hook to an anchor point on the aerial lift basket and/or a beam anchor secured to the raised platform. Responsive to determining that worker 10 has not utilized the article of PPE, AVR device may display a visual alert or sound an alarm via an audio device.

TAM 120 may further prompt user to complete training module 121C by completing a construction task, for example, guiding and securing a steel beam. TAM 120 may cause AVR device to display instructions to assist worker 10 to complete the task. In some examples, GUI 500G may be configured such that two or more simultaneous users may collaborate to complete the task in the same virtual environment. Responsive to TAM 120 receiving sufficient user input to determine the task has be completed, the aerial lift. Once the user has safely returned to the aerial lift, TAM 120 may terminate training module 121C and cause AVR device 49 to display the GUI's primary location (e.g., virtual locker room 502 in FIG. 5A). TAM 120 may await user input indicative of a selection of a new training module 121 from the menu (504 in FIG. 5A).

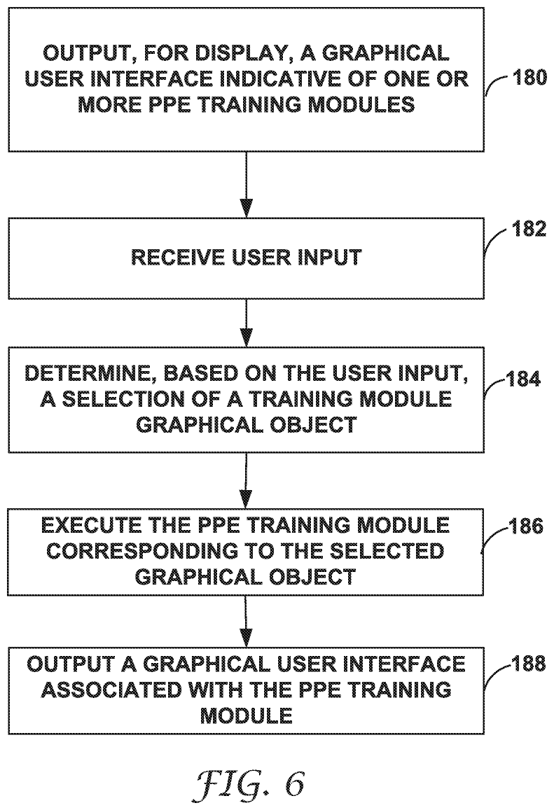

FIG. 6 is a flow chart depicting a method in accordance with some examples of this disclosure. The technique of FIG. 6 will be described with respect to computing device 110 of FIG. 3 and AVR device 49 of FIGS. 3 and 4. In other examples, however, other systems may be used to perform to perform the technique of FIG. 6.

Computing device 110 may output for display (e.g., by AVR device 49) a graphical user interface (GUI) indicative of one or more PPE training modules (180). For example, the GUI may include a graphical representation of an options menu featuring one or more graphical objects or elements, each graphical object representing a personal protective equipment (PPE) training module. The graphical objects displayed on the menu may each feature a short textual phrase describing the corresponding PPE training module, such as “CHECK SITE HAZARDS,” “CHECK ANCHORAGE INSTALLATIONS,” or “ERECT STEEL BEAM.”

Computing device 110 may receive data indicative of a user input in response to AVR device 49 displaying the GUI (182). For example, in response to viewing the menu, a user may utilize one or more input devices to select from the graphical objects displayed on the menu. Examples of user input devices are controllers, such as handheld controllers having one or more touchpads, joysticks, or buttons. Additionally or alternatively, the user may have affixed one or more position or motion sensors to one or more locations on his body, and may generate user input by physically moving the part of his body with the sensor attached to an intended position. Computing device 110 may receive data generated by a controller or sensor, where the data is indicative of the user input. For example, one or more sensors 108 may generate sensor data indicative of motion of the worker 10 or user 10 and may output the sensor data to computing device 110.

Responsive to receiving the data indicative of user input, computing device 110 may determines, based on the user input, a particular selection of one of the one or more graphical objects from the menu (184). For example, computing device 110 may compare the virtual position of a virtual element corresponding to the user input to the virtual position of the graphical object on the menu within the GUI. For example, a user having a position sensor associated with the physical position of his hand (for example, embedded within a handheld controller) may manipulate the orientation of a virtual avatar within the GUI by moving his hand with the sensor attached.

Computing device 110 may execute the PPE training module corresponding to the selected graphical object (186). For example, computing device 110 may retrieve data corresponding to the PPE training module and output a graphical user interface associated with the training module. In some examples, the system may query a local database to retrieve the module data. Alternatively, the system may retrieve the training module data from a remote storage device via a wired or wireless network connection.

Computing device 110 may output data indicative of a user interface associated with the training module to a display device, such as AVR device 49 (188). In one example, the system may execute the PPE training module by causing the display device to display a graphical representation of one or more virtual construction workers, each performing at least one construction task associated with at least one safety hazard, and prompting the user to determine whether the virtual construction worker appears to be wearing appropriate personal protective equipment for the task being performed. The system may receive user input indicative of a selection of one or more articles of PPE that the user has determined to be appropriate for the given construction task. The system may then confirm or reject the user's selection based on a set of “correct answer” data within the PPE training module data, by comparing the user's selection to the correct answer data, and outputting the system's determination for display to the user.

In another example, the system may execute the selected PPE training module by causing the display device to display a graphical representation of one or more PPE installations, such as anchor points, lifelines, or guardrails within a virtual construction site, and prompting the user to determine whether each installation appears to be properly installed. The system may receive user input indicative of a binary selection by the user, indicating whether the user believes the respective installation appears to be correctly installed. The system may then confirm or reject the user's selection based on a set of “correct answer” data within the PPE training module data, by comparing the user's selection to the correct answer data, and outputting the system's determination for display to the user.

In another example, the system may execute the selected PPE training module by causing the display device to display to the user a set of educational information regarding personal protective equipment, such as fall protection. The system may then prompt the user to select one or more articles of PPE, and receive user input indicative of the user's selection. In response, the system may cause the display device to display a graphical representation of the user's avatar wearing the one or more selected articles of PPE, such as in a virtual minor. The system may further execute the selected PPE training module by causing the display device to display a graphical representation of a simulation of a construction task involving the one or more articles of PPE selected by the user. For example, if the article of PPE selected by the user comprises an article of fall protection, the system may execute a simulation of a construction task involving the user working at a vertical height where the user is at risk of falling. For example, the simulation might include the user working above ground-level at a construction site, navigating an incomplete building under construction, and guiding a steel beam into place within the construction project. During the simulation, the system (or alternatively, a second user) may display a series of instructions to both educate and guide the user through the simulation.

It will be appreciated that numerous and varied other arrangements may be readily devised by those skilled in the art without departing from the spirit and scope of the invention as claimed. For example, each of the communication modules in the various devices described throughout may be enabled to communicate as part of a larger network or with other devices to allow for a more intelligent infrastructure. Information gathered by various sensors may be combined with information from other sources, such as information captured through a video feed of a work space or an equipment maintenance space. Thus, additional features and components can be added to each of the systems described above without departing from the spirit and scope of the invention as claimed.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A system comprising:
a display device configured to be worn by a user and to cover the user's eyes;
one or more sensors configured to detect motion of a user and output sensor data indicative of the motion; and
at least one computing device comprising a memory and one or more processors coupled to the memory, wherein the memory comprises instructions that cause the one or more processors to:
output, for display by the display device, a first graphical user interface, wherein the first graphical user interface includes a plurality of graphical elements associated with a respective training module of a plurality of training modules, wherein each training module represents a respective training environment associated with one or more articles of personal protective equipment;
determine, based on first sensor data output by the one or more sensors, a selection of a graphical element of the plurality of graphical elements, the graphical element associated with a particular training module of the plurality of training modules; and
output, for display by the display device, a second graphical user interface, wherein the second graphical user interface corresponds to the particular training module; and
execute the particular training module.

2. The system of claim 1, wherein the particular training module comprises one of:
training the user to identify appropriate first personal protective equipment associated with a first hazard,
training the user to identify whether second personal protective equipment associated with a second hazard is being utilized properly, or
training the user to properly utilize third personal protective equipment to perform a particular task in a work environment associated with a third hazard.

3. The system of claim 2, wherein the particular training module comprises training the user to identify the appropriate first personal protective equipment associated with the first hazard, wherein the memory comprises instructions that cause the one or more processors to:
output for display, an updated second graphical user interface, wherein the updated second user interface includes a graphical object representing a virtual worker in a virtual work environment and a plurality of graphical object that each represent a respective virtual article of personal protective equipment;
receive data indicative of a user input selecting a particular virtual article of personal protective equipment;
determine, based on the data indicative of the user input, whether the user identified the appropriate first personal protective equipment; and
output a notification in response to determining whether the user identified the appropriate first personal protective equipment.

4. The system of claim 3, wherein the instructions that cause the one or more processors to output the notification cause the one or more processors to output a notification indicating the appropriate first personal protective equipment in response to determining that the user did not identify the appropriate first personal protective equipment.

5. The system of claim 2, wherein the particular training module comprises training the user to determine whether the second personal protective equipment associated with the second hazard is being utilized properly, wherein the memory comprises instructions that cause the one or more processors to:
output for display, an updated second graphical user interface, wherein the updated second user interface includes a graphical object representing the second personal protective equipment and a graphical object indicating a prompt to identify whether the second personal protective equipment is being utilized properly;
receive data indicative of a user input indicating a response to the prompt;
determine, based on the data indicative of the user input indicating a response to the prompt, whether the response to the prompt was correct; and
output a notification in response to determining whether the response to the prompt was incorrect.

6. The system of claim 5, wherein the memory comprises instructions that cause the one or more processors to:
output for display a third graphical user interface, wherein the third graphical user interface includes a graphical object representing a 3-D model construction site having at least one icon associated with the second personal protective equipment;
receive a user input selecting a particular icon of the at least one icon; and
output the updated second graphical user interface that includes the second personal protective equipment in response to receiving the user input selecting the particular icon.

7. The system of claim 5, wherein the second personal protective equipment includes a fall arrestive device.

8. The system of claim 2, wherein the particular training module comprises training the user to perform the task while utilizing the third personal protective equipment in the work environment associated with the third hazard, wherein the memory comprises instructions that cause the one or more processors to:
output for display, an updated second graphical user interface, wherein the updated second user interface includes one or more graphical objects representing third personal protective equipment;
output, for display, a third graphical user interface that includes educational information about the third personal protective equipment; and
output, for display, a graphical representation of the user wearing the third personal protective equipment.

9. The system of claim 8, wherein the memory comprises instructions that further cause the one or more processors to:
output, for display, information to assist the user to perform the task.

10. The system of claim 8, wherein the third personal protective equipment comprises fall protection.

11. The system of claim 1, wherein the graphical user interface that represents the particular training module represents a first-person view of a particular training environment.

12. A device configured to be worn by a user and to cover the user's eyes, further configured to:
display a first graphical user interface, wherein the first graphical user interface includes a plurality of graphical elements associated with a respective training module of a plurality of training modules, wherein each training module represents a respective training environment associated with one or more articles of personal protective equipment; and
display a second graphical user interface, wherein the second graphical user interface corresponds to a particular training module.

13. The device of claim 12, wherein the particular training module comprises one of:
training the user to identify appropriate first personal protective equipment associated with a first hazard,
training the user to identify whether second personal protective equipment associated with a second hazard is being utilized properly, or
training the user to properly utilize third personal protective equipment to perform a particular task in a work environment associated with a third hazard.

14. The device of claim 13, wherein the particular training module comprises training the user to identify the appropriate first personal protective equipment associated with the first hazard, wherein the device is configured to:
display an updated second graphical user interface, wherein the updated second user interface includes a graphical object representing a virtual worker in a virtual work environment and a plurality of graphical object that each represent a respective virtual article of personal protective equipment;
display a notification indicating whether the user identified the appropriate first personal protective equipment.

15. The device of claim 14, wherein the notification indicates that the user did not identify the appropriate first personal protective equipment.

16. The device of claim 13, wherein the particular training module comprises training the user to determine whether the second personal protective equipment associated with the second hazard is being utilized properly, wherein the device is further configured to:
display an updated second graphical user interface, wherein the updated second user interface includes a graphical object representing the second personal protective equipment and a graphical object indicating a prompt to identify whether the second personal protective equipment is being utilized properly;
display a notification indicating whether a response to the prompt was incorrect.

17. The device of claim 16, further configured to:
display a third graphical user interface, wherein the third graphical user interface includes a graphical object representing a 3-D model construction site having at least one icon associated with the second personal protective equipment.

18. The device of claim 16, wherein the second personal protective equipment includes a fall arrestive device.

19. The device of claim 13, wherein the particular training module comprises training the user to perform the task while utilizing the third personal protective equipment in the work environment associated with the third hazard, wherein the device is further configured to:
display, an updated second graphical user interface, wherein the updated second user interface includes one or more graphical objects representing third personal protective equipment;
display, a third graphical user interface that includes educational information about the third personal protective equipment; and
display, a graphical representation of the user wearing the third personal protective equipment.

20. The device of claim 19, wherein the device is further configured to display information to assist the user to perform the task.

21-32. (canceled)
